(19) United States
(12) Patent Application Publication
(10) Pub. No.: US 2026/0222883 A1
(43) Pub. Date: Jul. 30, 2026

(54) HIGH-SPEED CSI PREDICTION WITH TIMING OFFSETS AND FREQUENCY OFFSETS IMPAIRMENTS VIA STATE SPACE MODELS

(71) Applicant: Samsung Electronics Co., Ltd., Suwon-si (KR)

(72) Inventors: Tianyu Li, Quebec (CA); Samuel Albert, Robbinsville, NJ (US); Yan Xin, Princeton, NJ (US); Jianzhong Zhang, Dallas, TX (US)

(21) Appl. No.: 19/456,989

(22) Filed: Jan. 22, 2026

Related U.S. Application Data
(60) Provisional application No. 63/751,705, filed on Jan. 30, 2025.
(60) Provisional application No. 63/828,809, filed on Jun. 23, 2025.

(51) Int. Cl. H04W 24/10; G06N 3/044

(52) U.S. Cl. CPC H04W 24/10; G06N 3/044

(57) ABSTRACT

Methods and apparatuses for a CSI prediction with timing and frequency offsets impairments via state space models in wireless communication systems. The method of a UE comprises: receiving a downlink signal; identifying, based on the downlink signal, an input data tensor in a frequency domain; computing, based on the input data tensor, a TTI-wise average to obtain a TTI-wise normalized value by performing a TTI-wise division operation; performing, based on the TTI-wise normalized value, a delay angle transformation to obtain RBs, wherein each of the RBs is identified as a different time step; encoding the input data tensor per-TTI channel matrix; identifying a prediction size of the input data tensor in a delay-angle domain using ML model; and performing, based on the prediction size, a frequency transformation for a channel prediction operation, wherein a decoder is used to recover a predicted channel after performing the channel prediction operation.

### CROSS-REFERENCE TO RELATED APPLICATIONS AND CLAIM OF PRIORITY

The present application claims priority to U.S. Provisional Patent Application No. 63/751,705, filed on Jan. 30, 2025, and U.S. Provisional Patent Application No. 63/828,809, filed on Jun. 23, 2025. The contents of the above-identified patent documents are incorporated herein by reference.

### TECHNICAL FIELD

The present disclosure relates generally to wireless communication systems and, more specifically, the present disclosure relates to a channel state information (CSI) prediction with timing and frequency offsets impairments via state space models in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a CSI prediction with timing and frequency offsets impairments via state space models in wireless communication systems.

In one embodiment, a user equipment (UE) in a wireless communication system is provided. The UE comprises a transceiver configured to receive, from a base station (BS), a downlink signal. The UE further includes a processor operably coupled to the transceiver, the processor configured to: identify, based on the downlink signal, an input data tensor in a frequency domain, compute, based on the input data tensor, a transmission time interval (TTI)-wise average to obtain a TTI-wise normalized value by performing a TTI-wise division operation, perform, based on the TTI-wise normalized value, a delay angle transformation to obtain resource blocks (RBs), wherein each of the RBs is identified as a different time step, encode, based on the RBs, the input data tensor per-TTI channel matrix, identify a prediction size of the input data tensor in a delay-angle domain using a machine learning (ML) model, and perform, based on the prediction size of the input data tensor, a frequency transformation for a channel prediction operation, wherein a decoder is used to recover a predicted channel after performing the channel prediction operation.

In another embodiment, a method of a UE in a wireless communication system is provided. The method comprises: receiving, from a BS, a downlink signal; identifying, based on the downlink signal, an input data tensor in a frequency domain; computing, based on the input data tensor, a TTI-wise average to obtain a TTI-wise normalized value by performing a TTI-wise division operation; performing, based on the TTI-wise normalized value, a delay angle transformation to obtain RBs, wherein each of the RBs is identified as a different time step; encoding, based on the RBs, the input data tensor per-TTI channel matrix; identifying a prediction size of the input data tensor in a delay-angle domain using a ML model; and performing, based on the prediction size of the input data tensor, a frequency transformation for a channel prediction operation, wherein a decoder is used to recover a predicted channel after performing the channel prediction operation.

In yet another embodiment, a non-transitory computer-readable medium comprising program code, that when executed by at least one processor, causes an electronic device to: receive, from a BS, a downlink signal; identify, based on the downlink signal, an input data tensor in a frequency domain; compute, based on the input data tensor, a TTI-wise average to obtain a TTI-wise normalized value by performing a TTI-wise division operation; perform, based on the TTI-wise normalized value, a delay angle transformation to obtain RBs, wherein each of the RBs is identified as a different time step; encode, based on the RBs, the input data tensor per-TTI channel matrix; identify a prediction size of the input data tensor in a delay-angle domain using a ML model; and perform, based on the prediction size of the input data tensor, a frequency transformation for a channel prediction operation, wherein a decoder is used to recover a predicted channel after performing the channel prediction operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of a channel prediction pipeline according to various embodiments of the present disclosure;

FIG. 8 illustrates an example of a data preprocessing pipeline according to various embodiments of the present disclosure;

FIG. 9 illustrates an example of SSM-based CHPD pipeline according to various embodiments of the present disclosure;

FIG. 10 illustrates an example of a unidirectional RNN according to various embodiments of the present disclosure;

FIG. 11 illustrates an example of a BRNN according to various embodiments of the present disclosure;

FIG. 12 illustrates an example of a GRU according to various embodiments of the present disclosure;

FIG. 13 illustrates an example of an LSTM according to various embodiments of the present disclosure;

FIG. 14 illustrates an example of a Mamba cell architecture according to various embodiments of the present disclosure;

FIG. 15 illustrates an example of a ResNet model structure and encoder/decoder frameworks according to various embodiments of the present disclosure;

FIG. 16 illustrates an example of an RB stacking for complexity reduction according to various embodiments of the present disclosure; and

FIG. 17 illustrates a flowchart of a method for a CSI prediction with timing and frequency offsets impairments via state space models according to various embodiments of the present disclosure.

### DETAILED DESCRIPTION

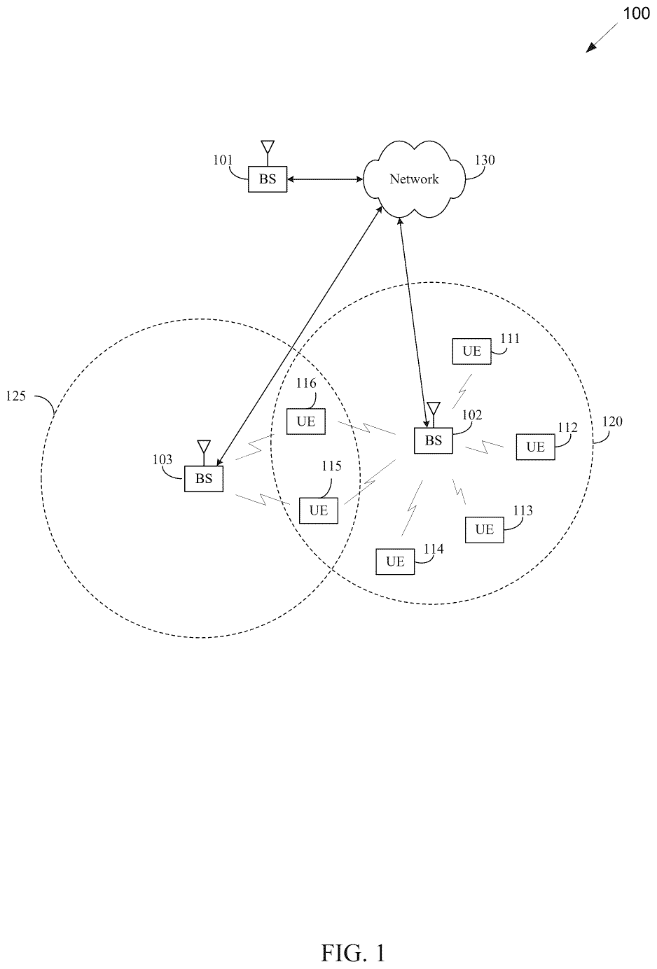

FIG. 1 through FIG. 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting a CSI prediction with timing and frequency offsets impairments via state space models in wireless communication systems. In certain embodiments, and one or more of the gNBs 101-103 includes circuitry, programing, or a combination thereof, to support a CSI prediction with timing and frequency offsets impairments via state space models in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

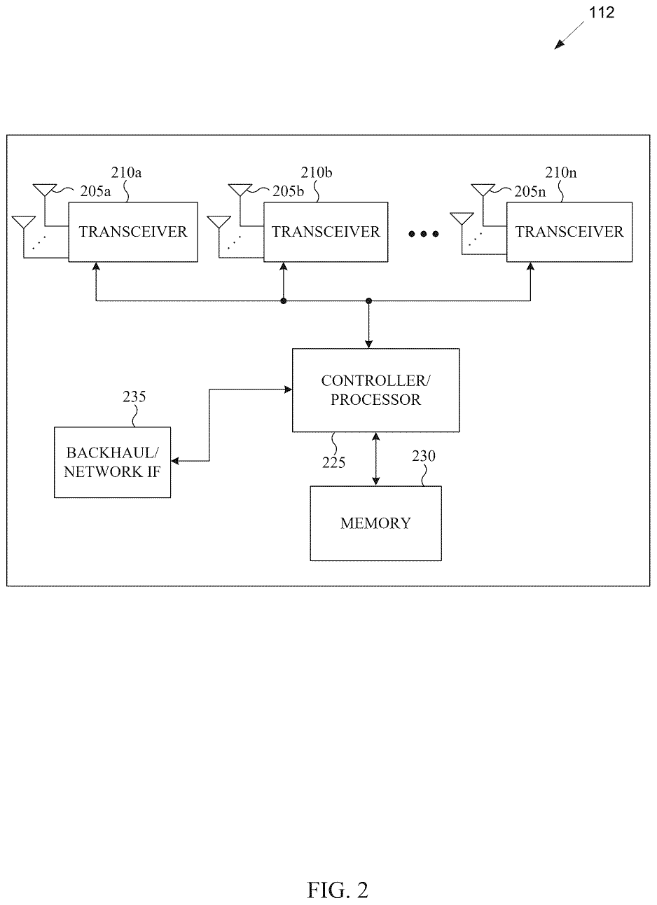

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a CSI prediction with timing and frequency offsets impairments via state space models in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

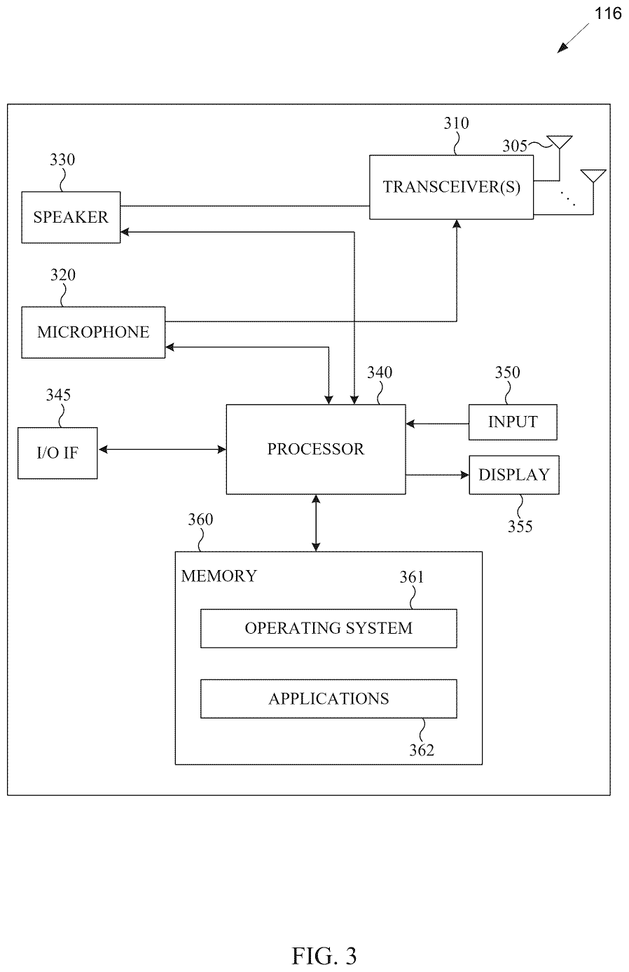

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a CSI prediction with timing and frequency offsets impairments via state space models in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates an example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

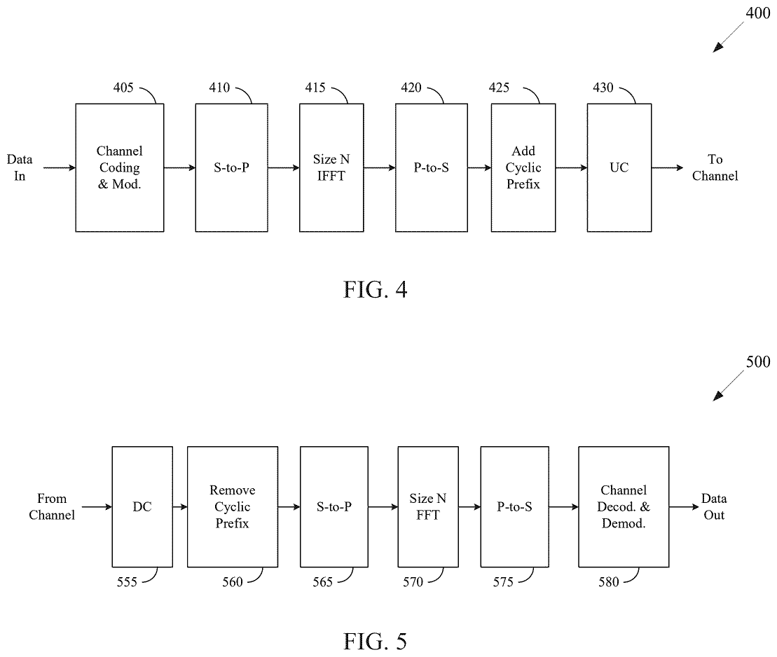

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architecture can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including reference signal (RS) CSI-RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

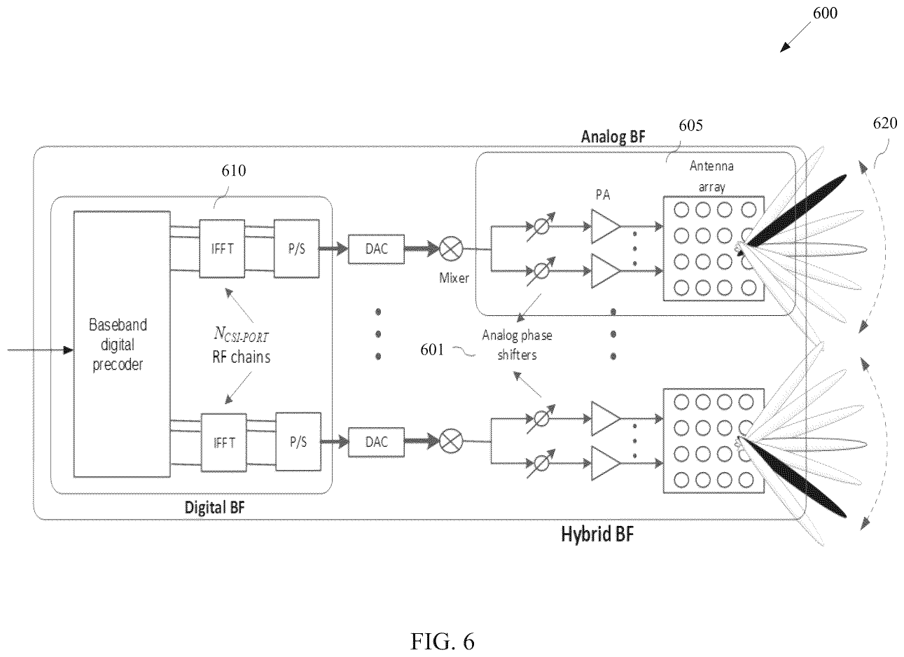

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the mentioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The mentioned system is also applicable to higher frequency bands such as >52.6 GHz. In this case, the system can employ only analog beams. Due to the O2 absorption loss around 60 GHz frequency (~10 dB additional loss at 100 m distance), larger number of and sharper analog beams (hence larger number of radiators in the array) may compensate for the additional path loss.

For a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size for a carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) cannot be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

Massive MIMO (mMIMO) is an important technology to improve the spectral efficiency of 4G and 5G cellular networks, and it has been adopted in Samsung massive MIMO unit (MMU). The number of antennas in mMIMO is typically much larger than the number of user equipment (UE), which allows BS to perform multi-user downlink (DL) beamforming to schedule parallel data transmission on the same time-frequency resources. However, its performance depends heavily on the quality of channel state information (CSI) at BS. It has been recently verified that the multi-user MIMO (MU-MIMO) performance degrades with UE mobility. CSI prediction can be used to combat the CSI aging; thus, the system can reduce the impact of processing delay and possibly the overhead. These problems are important to address especially at higher UE mobilities.

Data-driven (e.g., AI based) approaches can be utilized for CSI prediction, allowing model flexibility and applicability to the environment of interest. AI based channel prediction is one of the promising study cases in 3GPP for Rel-18. Due to the temporal nature of the CSI prediction problem, the use of state space models (SSM) such as recurrent neural networks (RNNs) are a promising candidate for such problem and can potentially bring significant benefits.

In MIMO systems, CSI becomes outdated quickly in highly dynamic environments, which is especially the case for mMIMO in which the BS relies on sounding reference signals sent by UE in the network. The UE also relies on scheduled pilot transmissions (e.g., CSI-RS) by the BS. This greatly reduces the performance of mMIMO MU-MIMO transmission with mobile UEs under highly dynamic environment. Being able to obtain accurate prediction of the future CSI under such environments is important in optimizing the performance of modern networks such as 5G and 6G, which may operate under stringent requirements for reliability, efficiency, and adaptability. By forecasting the evolution of the channel, communication systems can proactively adapt their transmission strategies, improve resource utilization, and enhance overall user experience.

Data driven approaches, e.g., machine learning based approaches, are promising ways to solve the problem as they can accurately capture the potential temporal dynamics of the CSI, especially catering to the environment of interest, thereby provide accurate prediction of the future channel. The present disclosure focuses on the problem of CSI prediction, where given the CSIs of the past L TTIs for a high-speed UE, the present disclosure provides an embodiment to obtain an ML model that predicts the next CSI accurately. Particularly, the present disclosure investigates the cases where the given past CSIs are corrupted by timing and frequency offsets impairments.

The present disclosure describes methods for leveraging state space models (SSMs) to predict future channel state information (CSI) of high speed user equipment (UEs) under timing offsets and frequency offsets (TOFO) impairments. The increasing deployment of high-speed UEs in modern wireless networks presents significant challenges for accurate CSI prediction. Moreover, the constant presence of TOFO disrupt conventional channel prediction techniques, leading to degraded performance in throughput, latency, and overall network reliability.

Signal processing methods often struggle to adapt to the dynamic and nonlinear nature of such distortions, especially in complex and dense deployment scenarios. To address this, AI-based approaches offer a transformative solution by leveraging machine learning models capable of capturing intricate patterns and temporal correlations in the wireless channel. These methods can effectively account for timing and frequency offsets, enabling robust prediction even with UEs of high mobility. By integrating AI-driven strategies, the present disclosure aims to bridge the performance gap, ensuring seamless connectivity and enhanced network performance in next-generation communication systems.

The present disclosure particularly focuses on the use of SSMs in the context of CSI prediction (CHPD). In some embodiments, the disclosed technology can include (i.e., but is not limited to): (i) a SSM-based framework for CSI prediction, which leverages the temporal nature of the CHPD problem. Moreover, by further exploiting the independence of different antennas as well as the temporal correlation over RBs under delay-angle domain transformation, it is able to circumvent the drawbacks of high dimensional input for SSM-based solutions. In addition, the framework is highly flexible w.r.t. the choice of SSM; (ii) an approach by leveraging vision encoder/decoder, particularly ResNet, as the per-TTI encoding and output decoding architecture, which significantly boosts the performance on SSM-based CHPD solutions; and (iii) an approach based on stacking adjacent RBs to create less time steps for SSM's forward computation, thereby drastically reducing the complexity of the model inference and training.

In one embodiment, a state space model based fast speed channel prediction with a timing offset and a frequency offset is provided.

A channel prediction is a vital task in wireless communication systems that aims to estimate the future state or characteristics of a communication channel. This process may be important for optimizing the performance of modern networks such as 5G and 6G, which may operate under stringent requirements for reliability, efficiency, and adaptability. By forecasting the evolution of the channel, communication systems can proactively adapt their transmission strategies, improve resource utilization, and enhance overall user experience.

In wireless systems, the communication channel serves as the medium through which signals are transmitted from a transmitter to a receiver. The properties of this channel are highly dynamic and are influenced by various factors, such as multipath propagation, the Doppler effect, and large-scale fading due to environmental changes. Multipath propagation occurs when transmitted signals arrive at the receiver through multiple paths, caused by phenomena like reflection, diffraction, and scattering. This results in constructive and destructive interference, making the received signal highly variable. Similarly, the Doppler effect, which arises from relative motion between the transmitter and receiver, introduces frequency shifts that further complicate the prediction task. Large-scale factors like path loss and shadowing, which depend on the distance and obstacles between the transmitter and receiver, also contribute to channel variability.

The primary objective of channel prediction is to accurately estimate these variations in a time, a frequency, or spatial domains. For instance, in a time-varying channel, predicting the future state based on past measurements allows the system to adapt transmission parameters such as power, modulation schemes, or coding rates. This can help mitigate the impact of fading or interference, ensuring reliable data transmission. Moreover, channel prediction facilitates the optimization of spectral efficiency by allowing communication systems to dynamically allocate resources such as bandwidth and antenna configurations.

Despite its significance, channel prediction is a challenging task due to the inherent complexity and unpredictability of wireless channels. The non-stationarity of the environment, particularly in scenarios with high mobility, means that channel characteristics can change rapidly over time. In addition, modern communication systems often involve high-dimensional scenarios, such as massive multiple-input multiple-output (MIMO) configurations, where the task of predicting the channel becomes computationally demanding. Environmental uncertainties, such as unexpected obstacles or weather changes, further add to the difficulty of building robust predictive models.

In wireless communication systems, predicting the channel for UEs moving at high speeds introduces significant challenges. The dynamic nature of the channel is exacerbated by rapid changes in the environment, leading to increased complexity in accurate prediction. In the present disclosure, it explores these challenges in detail. One of the primary challenges arises from the rapid temporal variations in the channel, often referred to as fast fading. As UEs move quickly, the relative positions of the transmitter, receiver, and surrounding objects change frequently. This leads to a rapid fluctuation of channel characteristics, such as signal amplitude, phase, and frequency response. The coherence time of the channel, which is the duration over which the channel can be considered approximately constant, becomes extremely short.

Prediction models that rely on the assumption of slow-changing channel conditions struggle to adapt in these scenarios. Moreover, high-speed UEs often move through diverse environments, such as urban areas, highways, or rural regions, each with unique propagation characteristics. This environmental non-stationarity introduces additional variability into the channel. For example, urban environments may introduce sudden obstructions or reflections from buildings, while highways may lead to rapid transitions between line-of-sight (LOS) and non-line-of-sight (NLOS) conditions. Adapting channel prediction models to account for such transitions in real time is challenging and of critical importance. In all our experiment setups, the UEs move at a speed of 30 km/h.

Apart from high speed UEs, this embodiment also aims to address the timing offset (TO) and frequency offset (FO) under the context of channel prediction. In wireless communication systems, a timing offset and a frequency offset are two critical impairments that affect the accuracy of channel prediction. These offsets often arise due to imperfections in synchronization between the transmitter and receiver and have significant implications for the performance of communication systems, particularly when channel prediction is employed to optimize transmission. Frequency offset arises from discrepancies between the carrier frequencies of the transmitter and receiver. These discrepancies may result from oscillator imperfections, Doppler shifts due to relative motion, or other environmental factors.

Frequency offset is quantified as the difference in a frequency between the transmitted and received carrier signals. The primary effect of frequency offset is the introduction of a phase rotation that accumulates over time. This phase rotation affects both the amplitude and phase of the signal, leading to distortion in the received waveform. TOFO includes a profound impact on the design and performance of channel prediction systems. Their combined effects can lead to significant degradation in prediction accuracy if not properly accounted for.

Statistical methods have been employed for channel prediction, leveraging models like autoregressive (AR) or autoregressive moving average (ARMA) processes to capture temporal dependencies. Additionally, a Kalmann filter can also be used to address the problem. However, these methods often struggle with the complexity and non-linearity of modern communication environments. In one embodiment, leverage machine learning methods are provided to perform the channel prediction task with TOFO impairments.

In one embodiment, a channel prediction formulation is provided. For example, let Hₜ∈ [symbol] ^{N}^{ₐ}^{×N}^{_{ƒ}} be the LS estimate of the channel at time step t, where Nₐ denotes the number of antennas and N_{ƒ} denotes the number of subcarriers/RBs. The channel prediction task is then to find a function ƒ_{θ}: [symbol] ^{N}^{ₐ}^{×N}^{_{ƒ×L}}␣ [symbol] ^{N}^{ₐ}^{×N}^{_{ƒ}}, which computers the mapping: H_{t-L}, H_{t-L+1}, . . . , Hₜ→Ĥₜ₊₁, where Ĥₜ₊₁ is the model's prediction of the channel at time step t+1, given the past l steps of the channel condition. Then for some loss function [symbol] : [symbol] ^{N}^{ₐ}^{×N}^{_{ƒ}}× [symbol] ^{N}^{ₐ}^{×N}^{_{ƒ}}→ [symbol] , it may find a parametrization θ of the function ƒ_{θ} such that [symbol] (Ĥₜ₊₁, Hₜ₊₁) is minimized. L is referred to as the time lag, measured in transmission time intervals (TTIs) in the future text.

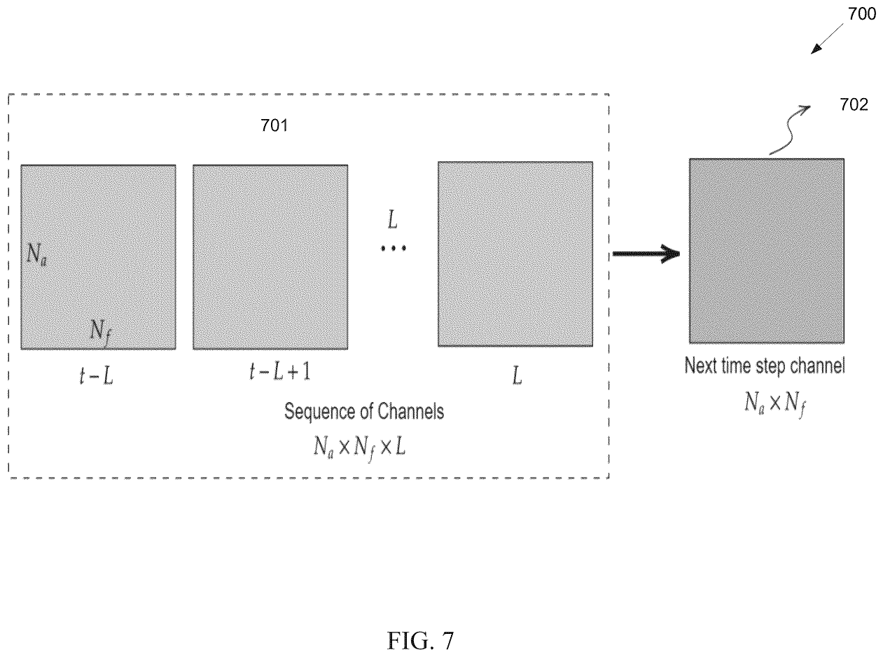

FIG. 7 illustrates an example of a channel prediction pipeline 700 according to various embodiments of the present disclosure. An embodiment of the channel prediction pipeline 700 shown in FIG. 7 is for illustration only.

As illustrated in FIG. 7, the channel prediction pipeline is illustrated. In 701, it may have the lag-L input data of the channels from the past L TTIs. Then, the data is used to predict 702, i.e., the channel at next time step Hₜ₊₁.

One baseline approach for the CHPD task is the so-called sample and hold method. The sample and hold method use the last time step channel input to predict the current time step channel. Namely it has: Ĥₜ₊₁=Hₜ.

In low-speed settings, the sample and hold approach is a fairly decent baseline and difficult to beat. However, under high-speed settings, due to the rapid fluctuation of channel characteristics, the sample and hold method becomes extremely unreliable. Therefore, better approaches may be performed. The present disclosure focuses on the high-speed setting with the UE speed set to 30 km/h.

In one embodiment, a formulation of TOFO impairments is provided.

In the present disclosure, it will be primarily focusing on CHPD task under TOFO impairments. At time step t, for the channel element of i-th antenna and k-th subcarrier, TOFO impairments can be simulated in the following fashion:

$${( {H}_{t}^{′} )}_{i , k} = {( {H}_{t} )}_{i , k} {e}^{j ( 2 π k Δ {T}_{t} + Δ {F}_{t} )} .$$

In such equation, j denotes imaginary number \sqrt{−1}, ΔTₜ is the TO realization at time step t and ΔFₜ is the FO realization at time step t.

For the TO realization, it may have: ΔTₜ=Δƒ_{RB}×randTOₜ×Tₛ where: (i) Δƒ_{RB} is the bandwidth of an RB. For LTE, Δƒ_{RB}=180 KHz; (ii) Tₛ is the sampling period. For LTE, Tₛ=32 ns; and (iii) randTOₜ=c+ϵ, where 0≤c<8 is a constant and ϵ is drawn uniformly from the set {−1, 0, 1}.

For the FO realization, it may have: ΔFₜ=randFO×ₜ. In such equation, randFO~U(−α, α) for some constant α and t is the TTI. For all experiments in the present disclosure, it may be assumed to let α=π.

Then the CHPD task under TOFO impairments can be formally defined as to find a function: ƒ_{θ}: [symbol] ^{N}^{ₐ}^{×N}^{_{ƒ×L}}→ [symbol] ^{N}^{ₐ}^{×N}^{_{ƒ}}, which computes the mapping:

$${H}_{t - L}^{′} , {H}_{t - L + I}^{′} , … , {H}_{t}^{′} ↦ {\hat{H}}_{t + 1} ,$$

where Ĥₜ₊₁ is the model's prediction of the clean channel at time step t+1, given the past l steps of the TOFO impaired channel conditions.

In one embodiment, an evaluation metric (e.g., Xcorrelation) is provided.

For the evaluation metric of the CHPD task, it opts to use Xcorrelation (Xcorr), as it is more closely related to the final throughput of the telecommunication networks. Formally, given a target channel matrix H and its prediction Ĥ of size Nₐ×N_{ƒ}, the Xcorrelation is defined as:

$$Xcorr ( \hat{H} , H ) = \frac{1}{{N}_{f}} {\sum }_{i = 1}^{{N}_{f}} \frac{\vert 〈 {\hat{H}}_{: , i} , {H}_{: , i} 〉 \vert}{‖ {\hat{H}}_{: , i} ‖ ‖ {H}_{: , i} ‖}$$

where ∥·∥ denotes complex norm associated with the complex inner product

$$〈 \cdot , \cdot 〉 , 〈 w , z 〉 = {\sum }_{j = 1}^{{N}_{a}} conj ( {w}_{j} ) {z}_{j} .$$

One can note this metric is invariant under phase shift. Namely for any Φ, Ĥ=H·e^{jΦ} gives the same XCorrelation performance.

Additionally, the range of Xcorrelation is from 0 to 1, with higher Xcorrelation score the better for the CHPD task. Within the scope of the present disclosure, it may be using Xcorrelation as the evaluation metric and it uses negative Xcorrelation as the loss function. However, all the provided methods of the present disclosure can be used with arbitrary loss functions and evaluation metrics. One can easily swap the loss function with the desired metric. All the embodiments provided in the present disclosure require no additional change.

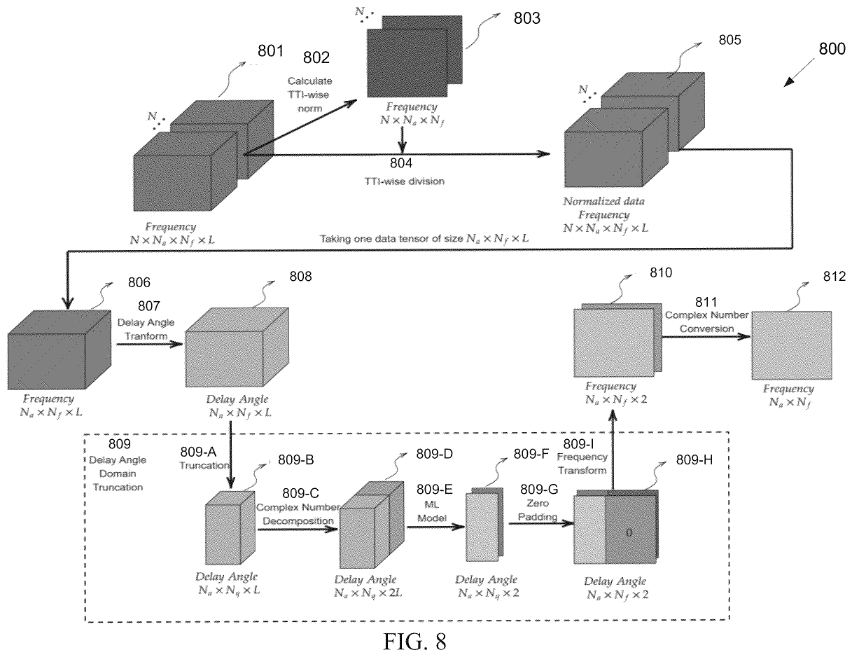

FIG. 8 illustrates an example of a data preprocessing pipeline 800 according to various embodiments of the present disclosure. An embodiment of the data preprocessing pipeline 800 shown in FIG. 8 is for illustration only.

In one embodiment, data preprocessing and postprocessing are provided. For data preprocessing, a pipeline is used as shown in FIG. 8. This method mainly uses the following two key preprocessing methods.

In one example, the method includes TTI-wise normalization, it may be noticed that different antennas and different subcarriers often tend to have different power magnitudes but the magnitudes along the TTI dimension are often consistent. Therefore, the present disclosure provides embodiment to perform the power normalization in an TTI-wise fashion. To do so, it may first obtain the TTI-wise average of the input tensor. Then each TTI slice of the input tensor is divided by the mentioned TTI-wise average. More formally, given an input tensor H′∈ [symbol] ^{N}^{ₐ}^{×N}^{_{ƒ×L}}, where n is the number of examples, l is the input lag (TTI-dimension), Nₐ is the number of antennas and N_{ƒ} is the number of subcarriers, the TTI-wise average Z∈ [symbol] ^{N}^{ₐ}^{×N}^{ₐ}^{×N}^{_{ƒ}} is obtained by

$$Z = \frac{1}{L} {\sum }_{i = 1}^{L} {H}_{: , : , : , i}^{′} .$$

Then it performs the TTI-wise normalization by doing the elementwise division of the two tensors:

$${H}_{: , : , : , i}^{′} = \frac{{H}_{: , : , : , i}^{′}}{Z} , ∀ i ∈ [ L ] .$$

In another example, the method includes a delay-angle domain transformation. The input data comes in under frequency domain. It performs delay-angle domain transformation by first converting the data from frequency domain to delay domain using inverse discrete Fourier transformation (IDFT) along the subcarrier dimension. Then the data is converted from delay domain to delay-angle domain by performing another IDFT along the antenna dimension.

Overall, the data preprocessing and post processing goes as the following. In operation 801, the input data tensor under frequency domain is received. Then, in operation 802, the TTI-wise average is computed and the TTI-wise normalization is applied in operation 804 by performing TTI-wise division. Then in operation 807, the delay angle transformation is performed and the output of such process is obtained in 808. Then it keeps the first N_{q} RBs while truncating the remaining N_{ƒ}-N_{q} RBs by performing the truncation operation in operation 809-A. This gives us an input tensor of shape Nₐ×N_{q}×L. Then the input complex tensor is decomposed into its real and imaginary parts in operation 809-C, obtaining the input tensor of shape Nₐ×N_{q}×L.

Then it feeds the truncated input tensor through an arbitrary ML model and obtains a prediction of size Nₐ×N_{q}×2 under delay-angle domain in operation 809-F. As illustrated in the present disclosure, except for the first few RBs, all the remaining RBs under the delay-angle domain often exhibit negligible or zero signal power. Therefore, in operation 809-G, a zero-padding is performed on the obtained prediction, where it pads zeros on the RBs dimension to reach to the prediction size of Nₐ×N_{ƒ}×2. Last but not least, the prediction is predicted back to frequency domain and obtain the final prediction.

In one embodiment, state space models (SSMs) are provided. SSMs are a powerful mathematical framework for representing dynamical systems that evolve over time. They are particularly useful in machine learning when modeling processes with inherent temporal dependencies or sequential patterns. At their core, SSMs aim to describe how a system's latent state evolves and how this hidden state relates to observable data. These models are widely employed in fields such as time series analysis, signal processing, control theory, and reinforcement learning.

The formal structure of an SSM comprises two key equations: the state equation (or state transition function), which governs the evolution of the hidden state over time, and the observation equation (or output function), which links the hidden state to the observed data. The SSM in the present disclosure may be a discrete-time discrete-state SSM. Mathematically, these equations for the specific type of SSM can be expressed as follows: hₜ₊₁=ƒ(hₜ, xₜ) and yₜ=h(hₜ, xₜ) where hₜ∈ [symbol] ^{k} represents the latent state at time step t, xₜ∈ [symbol] ^{c} denotes the input at time step t, ƒ: [symbol] ^{k}× [symbol] ^{c}→ [symbol] ^{k} is the state transition function, and h: [symbol] ^{k}× [symbol] ^{c}→ [symbol] ^{o} is the output function. Note that some SSMs only take the hidden state as the input to obtain the current step prediction, i.e., h: [symbol] ^{k}→ [symbol] R^{o}.

In state space models, the functions ƒ and h are often linear, leading to models such as the well-known linear dynamical system (LDS). When both the process noise and observation noise are Gaussian, the Kalman filter provides an optimal solution for state estimation. However, many real-world problems exhibit complex, nonlinear dynamics, which may necessitate the use of nonlinear state space models. In these cases, ƒ and h are general nonlinear functions, and specialized techniques such as the extended Kalman Filter (EKF) or particle filters are employed for inference.

In machine learning systems, SSMs play a crucial role in tasks involving sequential data. For example, in time series modeling, they capture the temporal structure and underlying latent dynamics, which is essential for forecasting future values. SSMs have also found extensive applications in speech recognition, where the widely used hidden Markov model (HMM) can be viewed as a discrete-state version of an SSM. In such models, inference involves estimating the most probable sequence of states given a sequence of observations.

The intersection of state space models with deep learning has given rise to deep state space models, where neural networks are employed to represent the complex functions ƒ and h. Recurrent neural networks (RNNs), long short-term memory networks (LSTMs), and gated recurrent units (GRUs) can be interpreted as specific forms of SSMs, where the hidden state evolves according to recurrent dynamics parameterized by neural networks.

The versatility of state space models has led to applications in a wide range of fields. In control systems, they are used to model the behavior of dynamic environments and design optimal controllers. In signal processing, they enable filtering and prediction tasks, such as denoising and tracking. Econometrics relies on SSMs to model complex economic time series data, capturing trends, cycles, and stochastic shocks. In healthcare, SSMs are applied to physiological signal monitoring, such as electrocardiograms (ECG) or electroencephalograms (EEG), for tasks like anomaly detection and patient monitoring.

Despite their broad applicability, SSMs face several challenges. One significant issue is scalability: high-dimensional state spaces and long sequences can make exact inference computationally infeasible. Recent advances in machine learning, particularly the integration of deep learning with probabilistic modeling, have addressed some of these limitations by enabling scalable inference and learning. Moreover, hybrid models that combine state space models with other paradigms, such as Gaussian processes or reinforcement learning, represent a promising direction for future research.

In one embodiment, a channel prediction with state space models is provided. In the present disclosure, the pipeline is provided for leveraging SSMs to tackle the channel prediction problem. One natural idea is to treat the channel at each time step as the input and use an SSM to model the dynamics w.r.t., the channel sequence. However, this type of approach, due to the fact that the channel often comes as a high dimensional image input, entails SSMs with high complexity.

Although one can use an encoding structure to lower the input dimension, this may often lead to suboptimal solution with the channel prediction task. Additionally, ConvLSTM based approach has been experimented to tackle the CHPD problem. ConvLSTM maintains the spatial-aware hidden states by leveraging convolution operations in updating the state. However, due to the particularly large state size, ConvLSTM based methods suffer significant computational overhead and memory constraints. In terms of telecommunication applications, this could lead to extensive costly upgrades to the network infrastructure and therefore a more computationally efficient approach may be sought out.

In such example, the present disclosure provides an embodiment to treat each RB under delay-angle transformation as different time steps. That is, given a decomposed delay angle domain representation, i.e., step 809-B, of the input data tensor of size N×Nₐ×N_{ƒ}×2L, in the special case where antenna correlation may not be accounted for, each antenna is treated as an independent sequence and first merge the antenna dimension into the sequence number dimension, resulting in an input tensor of size (N×Nₐ)×N_{ƒ}×2L. Note now instead of having N number of sequences, it has N×Nₐ number of sequences. Then, the RB dimension is merged with the TTI dimension and separate it from the original features dimension.

This operation gives a data tensor of size (N×Nₐ)×(N_{ƒ}×L)×2. Note that this tensor can be seen as an input data of N×Nₐ sequences, which has 2 features at each time step and each of these sequences has N_{ƒ}×L time steps. To clarify with the remaining part of this embodiment, it may keep the original TTI dimension (i.e., L) as it is and rename this merged N_{ƒ}×L dimension as the time dimension. Consequently, it may refer to each element of the TTI dimension as TTI, e.g., TTI=1, TTI=L, and it may refer to each element of the new time dimension as time step. Then this input data can be processed by an arbitrary SSM and obtain a prediction under some proper frequency domain transformation.

In the case where correlation across antenna may be accounted for, it may consider an antenna mapping η:

$${ℝ}^{{N}_{a} \times {N}_{f} \times 2} \to {ℝ}^{{N}_{a}^{′} \times {N}_{f} \times 2 d}$$

for some d∈ [symbol] ⁺ where Nₐ mod d=0 and

$${N}_{a}^{′} = \frac{{N}_{a}}{d} .$$

Note that when d=1, η is an identity map, which is the exact same procedure as described above. For the cases where d is larger than 1, η first permutes the antennas according to some permutation ξ: A→A, where A is the set of all antennas. Then for every d number of antennas, η stacks them together onto the feature dimension, thereby resulting in a reshaped tensor of shape

$${N}_{a}^{′} \times {N}_{f} \times 2 d .$$

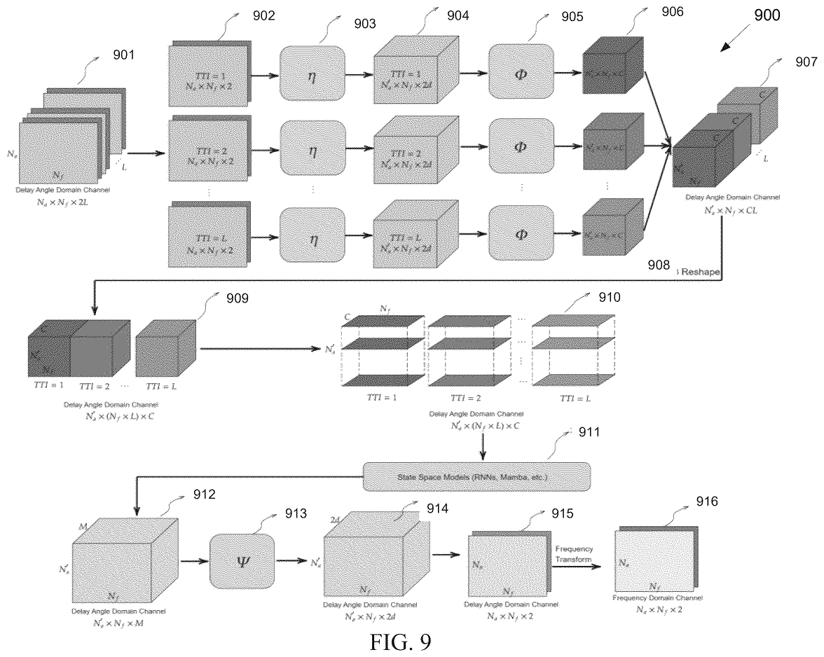

It may refer to the detailed procedure in FIG. 9.

FIG. 9 illustrates an example of SSM-based CHPD pipeline 900 according to various embodiments of the present disclosure. An embodiment of the SSM-based CHPD pipeline 900 shown in FIG. 9 is for illustration only.

In one example, it also incorporates a per-TTI encoder Φ and a final output decoder Ψ, where Φ: Nₐ×N_{ƒ}×2→Nₐ×N_{ƒ}×C is the per-TTI encoder which is shared across the input at different TTI and Ψ: Nₐ×N_{ƒ}×M→Nₐ×N_{ƒ}×2 is the output decoder. Note that C is the encoding dimension and M is the output dimension of the SSM. Specifically, in FIG. 9, the general pipeline of leveraging SSM is illustrated for the CHPD task.

It begins with the delay angle domain representation of the input tensor block in operation 901, which is the same as in operation 808 or operation 809-B where N_{q}=N_{ƒ}, i.e., no truncation (note the pipeline applies to the truncation cases as well). Then in operation 902, it splits each TTI and feeds them separately into the antenna mapping η in operation 903 and obtains the output in 904 where each TTI has the input tensor of shape

$${N}_{a}^{′} \times {N}_{f} \times 2 d .$$

It then feeds them separately into the encoder Φ in operation 905. As mentioned before, Φ is shared across all TTIs.

In operation 906, the per-TTI encoded data is of size

$${N}_{a}^{′} \times {N}_{f} \times C .$$

Subsequently, these data blocks are recombined along the TTI dimension, which results in the data tensor of size

$${N}_{a}^{′} \times {N}_{f} \times CL$$

in operation 907. From 901 to 907, the input data is encoded from 2 features per TTI to C features per TTI, while reducing the number of antennas from Nₐ to

$${N}_{a}^{′} .$$

Then in operation 908, a reshaping is performed on the data tensor, which essentially rearranges the blocks in 906 and stack them in a horizontal fashion. This reshaping operation then gives a data tensor of size

$${N}_{a}^{′} \times ( {N}_{f} \times L ) \times C$$

in 909. Then each row of the tensor is treated as independent sequence, which is illustrated in operation 910. This results in a dataset of

$${N}_{a}^{′}$$

sequences of length N_{ƒ}×L where each time step has C features.

Then in operation 911, one can choose a desired SSM that takes as input of size (N_{ƒ}×L)×C and computes an output of size N_{ƒ}×M. This operation is carried out for each sequence of data tensors in 910. Therefore, 711 produces

$${N}_{a}^{′}$$

number of output sequences of size N_{ƒ}×M and in operation 912, the output tensor is of size

$${N}_{a}^{′} \times {N}_{f} \times M .$$

Subsequently, the output of the SSM is fed into the decoder Ψ in operation 913 and computes the final delay angle domain output of size

$${N}_{a}^{′} \times {N}_{f} \times 2 d$$

in 914. Then it is reshaped to its original shape Nₐ×N_{ƒ}×2 in operation 915 and finally converted back to the frequency domain in 916.

There are many viable candidates for the choice of the encoder and the decoder architecture, such as linear operators, MLP etc. In this embodiment, an identity mapping is used as the encoder and uses a matrix of size M×2 as the linear decoder. The present disclosure provides an embodiment(s) for leveraging vision models, particularly ResNet as the encoder/decoder architecture. In some cases, the use of other types of encoder/decoders can be provided by other approaches (e.g., future approaches). Note that all other approaches leveraging the same pipeline as outlined in FIG. 9, albeit with other types of encoder/decoder or SSM, fall under this embodiment.

Additionally, although it sets the encoder φ to be shared across all TTIs for illustration purposes, one can easily modify the architecture so that each TTI has its own different encoder. Note that this may increase the model complexity significantly with large L value and may potentially cause overfitting if not enough training data is provided.

In one embodiment, RNN-based SSMs are provided. Recurrent neural networks (RNNs) may be a class of artificial neural networks designed for sequence data. Unlike feedforward neural networks, RNNs have connections that allow information to persist across different steps in a sequence. This capability makes RNNs particularly suitable for tasks where context and temporal dynamics are important, such as time series analysis, natural language processing, and signal processing. RNNs process sequences of data one step at a time, maintaining a hidden state that captures information from previous steps. The same weights are used for all steps in the sequence, enabling the model to generalize across different positions in the sequence. During training, RNNs leverages backpropagation through time (BPTT) which unrolls the network through time to compute gradients.

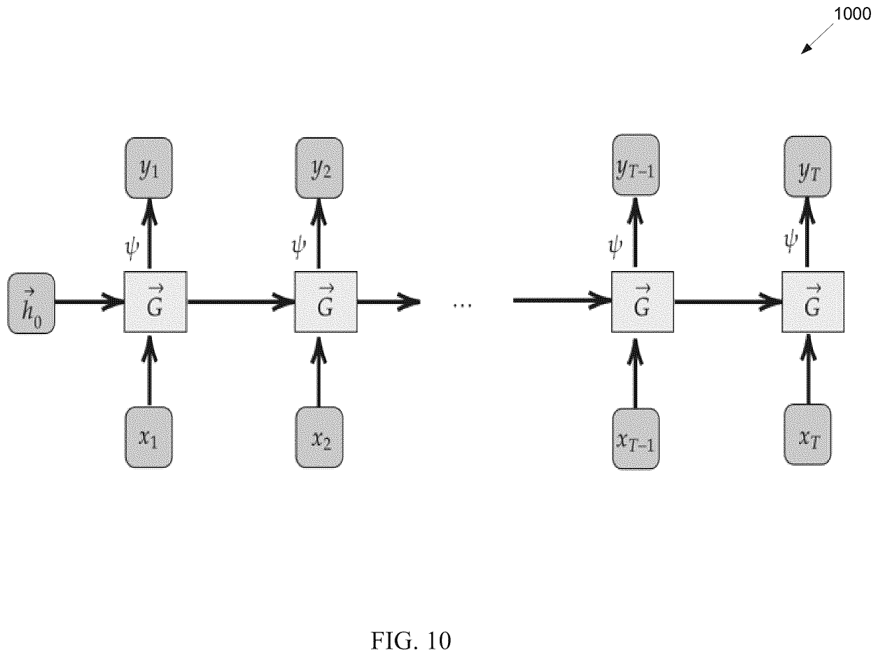

FIG. 10 illustrates an example of a unidirectional RNN 1000 according to various embodiments of the present disclosure. An embodiment of the unidirectional RNN 1000 shown in FIG. 10 is for illustration only.

In FIG. 10, a unidirectional RNN is illustrated where the input data sequence x₁, . . . , x_{T}∈ [symbol] ^{d} is fed into the network and obtain the output sequence of y₁, . . . , y_{T}∈ [symbol] ⁰. An (unidirectional) RNN is defined as a tuple R=<\vec{h}₀, \vec{G}, ψ>, where \vec{h}₀∈ [symbol] ^{k} is the initial hidden state, \vec{G}: [symbol] ^{k}× [symbol] ^{d}→ [symbol] ^{k} is the forward transition function and ψ: [symbol] ^{k}→ [symbol] ^{o} is the output function. An RNN computes the following function: \vec{h}ₜ₊₁=\vec{G}(\vec{h}ₜ, xₜ) and yₜ₊₁=ψ(\vec{h}ₜ₊₁).

Note the definition for RNN in this illustration is of a sequence to sequence type of equivalent length, i.e., the length of the input sequence is the same as the length of the output sequence, formally, R: [symbol] ^{d×T}→ [symbol] ^{o×T}. This can be easily generalized to the cases where the output length is smaller than the input sequence length, i.e., R: [symbol] ^{d×T}→ [symbol] ^{o×L} where L≤T. This can be done by taking the last L outputs as the final prediction from the above computation, i.e., y_{T-L}, . . . , y_{T}.

Although RNNs have achieved numerous accomplishments, they can only leverage information in a unidirectional fashion, namely they only have access to the past information prior to current time step. Applications like language modelling, signal denoising and seq2seq translations may require the model to be able to take bidirectional information. Bidirectional Recurrent Neural Networks (BRNNs) extend the idea of standard RNNs by processing the input sequence in both forward and backward directions. This allows the network to have both past and future information at every time step. BRNNs maintain two hidden states per time step—one for processing the sequence forwardly and one for processing it backwardly.

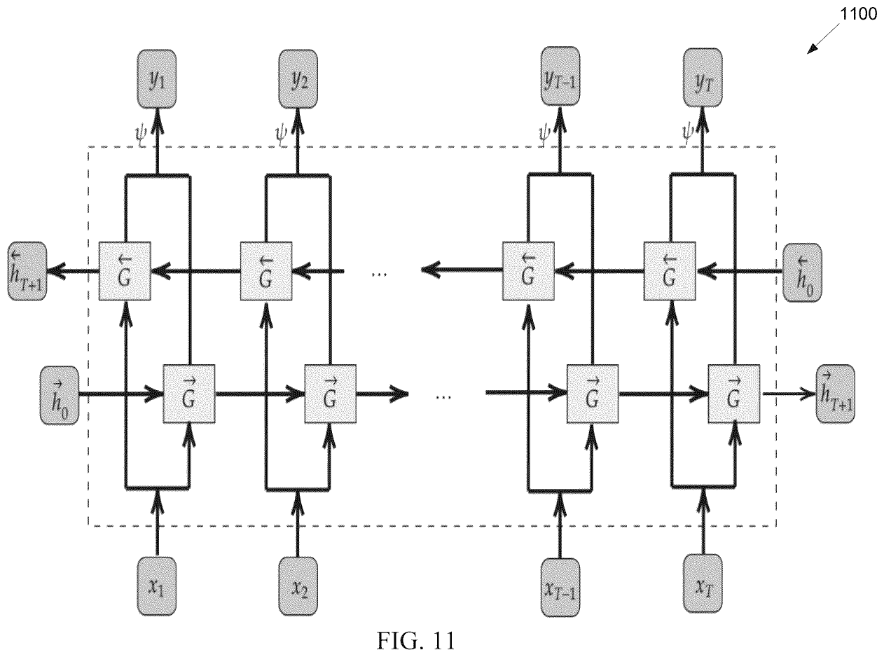

FIG. 11 illustrates an example of a BRNN 1100 according to various embodiments of the present disclosure. An embodiment of the BRNN 1100 shown in FIG. 11 is for illustration only.

By leveraging information from both directions, BRNNs can capture more contextual information, leading to improved performance on tasks where understanding the context from both past and future is crucial. The diagram of BRNNs can be found in FIG. 11.

A bidirectional RNN is defined as a tuple R=<\vec{h}₀, \vec{G}, h₀, \vec{G}, ψ>, where \vec{h}₀∈ [symbol] ^{k} is the forward initial hidden state, \vec{G}: [symbol] ^{k}× [symbol] ^{d}→ [symbol] ^{k} is the forward transition function, \vec{h}₀∈ [symbol] ^{k} is the backward initial hidden state, \vec{G}: [symbol] ^{k}× [symbol] ^{d}→ [symbol] ^{k} is the backward transition function and ψ: [symbol] ^{k}× [symbol] ^{k}→ [symbol] ^{o} is the output function. A bidirectional RNN computes the following function:

$${\vec{h}}_{t + 1} = \vec{G} ( {\vec{h}}_{t} , {x}_{t} ) , {\overleftarrow{h}}_{t + 1} = \overleftarrow{G} ( {\overleftarrow{h}}_{t} , {x}_{t} ) , and {y}_{t + 1} = ψ ( {\vec{h}}_{t + 1} , {\overleftarrow{h}}_{t + 1} ) .$$

RNNs opt to use linear mapping followed by a nonlinear activation function as the state transition function. This set-up often suffers from the vanishing gradient problem, where gradients propagated through many time steps can become extremely small, preventing the network from learning long-term dependencies effectively. This issue limits the capability of RNNs to retain information over long sequences. The introduction of gating mechanisms in long short-term memory (LSTM) networks and gated recurrent unit (GRU) networks was a significant breakthrough in overcoming this limitation. Gating mechanisms allow the network to control the flow of information, enabling better handling of dependencies across different time steps.

LSTMs introduce a cell state that runs through the entire sequence, providing a pathway for gradients to flow without vanishing. LSTMs use three gates—the input gate, the forget gate, and the output gate—to regulate the cell state and the hidden state. Gated recurrent units (GRUs) simplify the LSTM architecture by combining the forget and input gates into a single update gate and using a reset gate to control the candidate activation. The update gate decides how much of the past information may be passed along to the future, while the reset gate determines how much of the past information to forget. Compared to long short-term memory (LSTM) networks, GRUs have a simpler architecture with fewer parameters, which can make them faster to train and easier to implement. GRUs have been shown to perform comparably to LSTMs on many tasks while being computationally more efficient. In FIG. 6, the structure of the GRU is illustrated.

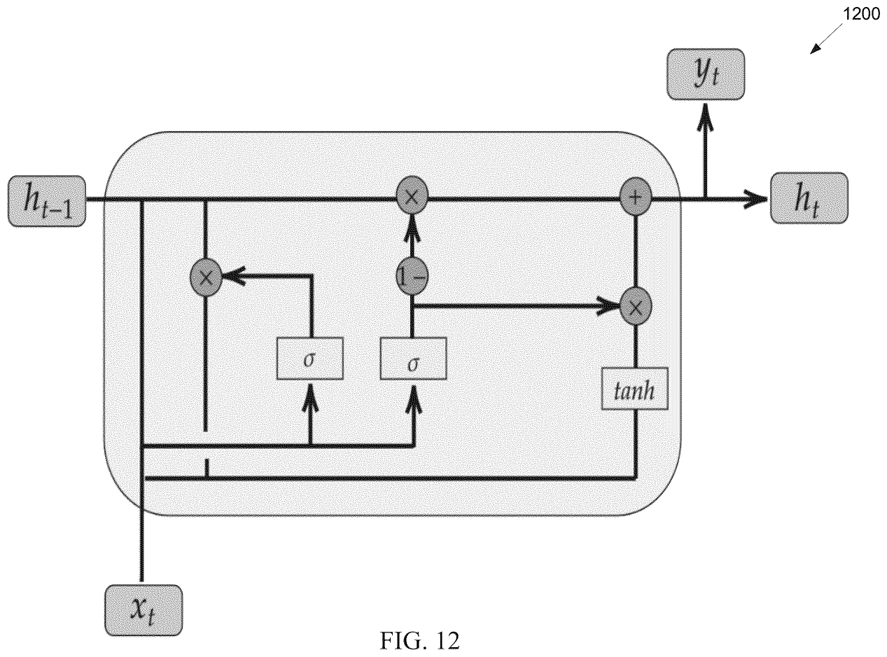

FIG. 12 illustrates an example of a GRU 1200 according to various embodiments of the present disclosure. An embodiment of the GRU 1200 shown in FIG. 12 is for illustration only.

In FIG. 12, a diagram for the GRU cell computation is illustrated. GRU updates the hidden state in the following fashion: zₜ=σ(W_{z}xₜ+U_{z}hₜ₋₁+b_{z}), rₜ=σ(Wᵣxₜ+Uᵣhₜ₋₁+bᵣ), ĥₜ=φ(Wₕxₜ+Uᵣ(rₜ⊙hₜ₋₁)+bₕ), and hₜ=(1−zₜ)⊙hₜ₋₁+zₜ⊙ĥₜ.

In such equation, ⊙ denotes Hadamard (elementwise) multiplication, σ is a logistic function and φ is a hyperbolic tangent function.

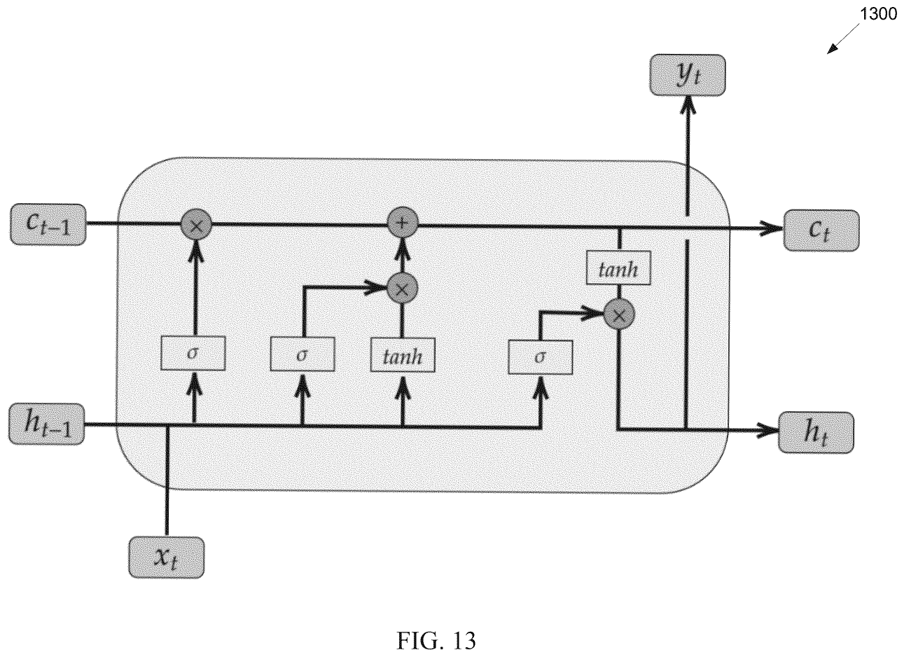

FIG. 13 illustrates an example of an LSTM 1300 according to various embodiments of the present disclosure. An embodiment of the LSTM 1300 shown in FIG. 13 is for illustration only.

In FIG. 11, a diagram for the LSTM cell computation is illustrated. LSTM updates the hidden state in the following fashion: ƒₜ=σ(W_{ƒ}xₜ+U_{ƒ}hₜ₋₁+b_{ƒ}), iₜ=σ(Wᵢxₜ+Uᵢhₜ₋₁+bᵢ), oₜ=σ(Wₒxₜ+Uₒhₜ₋₁+bₒ), \tilde{c}ₜ=φ(W_{c}xₜ+U_{c}hₜ₋₁+b_{c}), cₜ=ƒₜ⊙cₜ₋₁+iₜ⊙\tilde{c}ₜ, and hₜ=oₜ⊙φ(cₜ).

In such equation, ⊙ denotes Hadamard (elementwise) multiplication, σ is a logistic function and φ is a hyperbolic tangent function.

In one embodiment, Mamba-based SSMs are provided. Mamba, short for linear-time sequence modeling with selective state spaces, is a novel framework designed to efficiently model long sequences by leveraging selective state space updates. State space models (SSMs) have demonstrated great success in sequence modeling tasks, such as time series forecasting and natural language processing. However, these models often struggle with computational inefficiencies when dealing with long sequences, primarily due to the dense nature of their state updates. MAMBA addresses this challenge by introducing a mechanism that performs selective updates to the latent state, ensuring linear-time complexity while maintaining high modeling fidelity.

The core idea of Mamba lies in its selective state update mechanism. Rather than performing dense updates at every time step, Mamba selectively updates only the most relevant parts of the state, inspired by the observation that in many real-world sequences, only a subset of elements significantly affects the overall dynamics. Unlike conventional state space models, where the computational complexity scales quadratically with the sequence length O(T²), Mamba achieves linear complexity O(T), by exploiting sparsity in the state updates. This makes the model highly scalable, even for extremely long sequences, without sacrificing its ability to capture long-range dependencies.

Mamba's design makes it particularly well-suited for a wide range of sequential tasks that may require modeling long-range dependencies. In time series forecasting, Mamba can efficiently model temporal dynamics over long horizons, making it ideal for tasks such as weather prediction, financial forecasting, and energy demand modeling. In the field of natural language processing, Mamba's ability to handle long sequences without the quadratic complexity of transformers presents a compelling alternative for language modeling, sentiment analysis, and machine translation. Additionally, MAMBA has significant potential in speech and signal processing, where long-range dependencies play a crucial role in tasks such as speech synthesis and audio generation.

Mamba offers several distinct advantages over state space models. Its scalability, achieved through linear-time complexity, allows it to handle long sequences that may be computationally prohibitive for other models. The selective state update mechanism ensures that computational resources are focused on the most informative parts of the sequence, leading to improved efficiency without compromising accuracy. Furthermore, Mamba's flexibility enables its application across a diverse set of domains, making it a versatile framework for modern sequence modeling tasks.

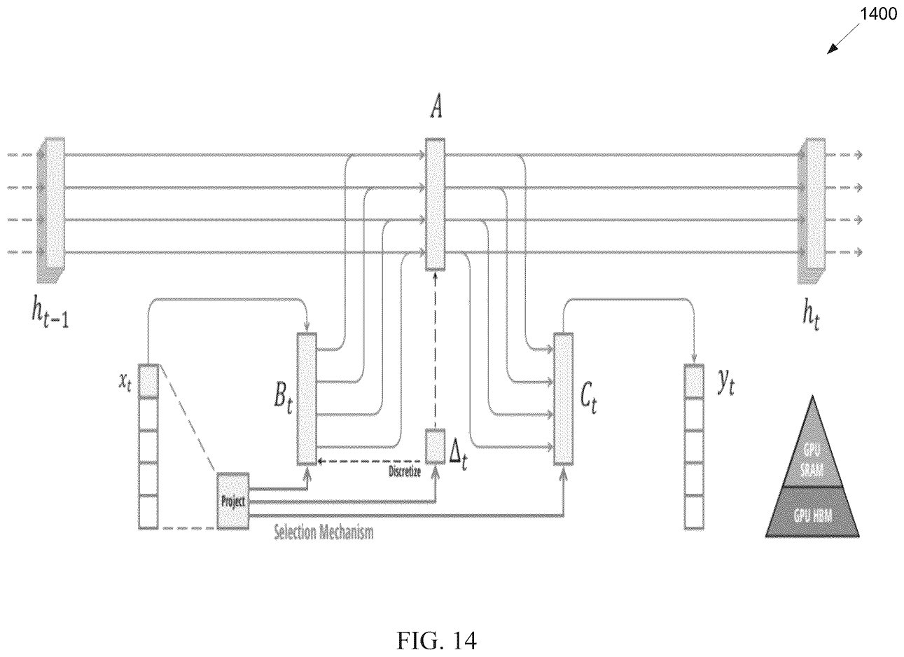

FIG. 14 illustrates an example of a Mamba cell architecture 1400 according to various embodiments of the present disclosure. An embodiment of the Mamba cell architecture 1400 shown in FIG. 14 is for illustration only.

In FIG. 14, the cell architecture of Mamba is illustrated. Given an input vector xₜ∈ [symbol] ^{d} and an output vector yₜ∈ [symbol] ^{o}, a Mamba cell at time step t of size k includes 4 parameters <Δₜ, A, Bₜ, Cₜ>, where Aₜ∈ [symbol] , A∈ [symbol] ^{k×k}, Bₜ∈ [symbol] ^{d×k}, Cₜ∈ [symbol] ^{K×o}. A Mamba cell updates the state and obtains the output in the following fashion:

$${B}_{t}^{′} , {Δ}_{t} , {C}_{t} = {f}_{p r o j} ( {x}_{t} ) , {A}_{t} , {B}_{t} = {f}_{d i s c} ( A , {B}_{t}^{′} , {Δ}_{t} ) , {h}_{t}^{T} = {h}_{t - 1}^{T} {A}_{t} , and$$

$${\hat{y}}_{t}^{T} = {h}_{t}^{T} {C}_{t} .$$

Where ƒₚᵣₒⱼ is a linear projection function and ƒ_{disc} is the discretization function, of which people typically use the zero-order hold method. Note that the Δₜ, Bₜ, Cₜ are computed on the fly given the current input xₜ and therefore the Mamba cell is time variant, unlikely the RNN-based architectures.

The present disclosure provides experiment results with various SSMs. The bidirectional GRU networks are provided first. In experiments, it explores the effect of the parameter L, i.e., the TTI lag. For this experiment, it uses an identity encoder, and a linear decoder as illustrated in FIG. 9. It uses an identity mapping for the antenna mapping η, i.e., d=1 for all our experiments. It sets the hidden state dimension to be 32 and the number of layers to be 3 for this experiment. It uses 460,265 training examples across the board, which are generated from 5 random seeds from a simulator, and it evaluates the performance on a different testing set with 91,104 examples. In all datasets, the UEs move at a speed of 30 km/h. In the present disclosure, it may use the same training and testing data sets. For training, it uses Adam optimizer with a learning rate of 0.001. In addition, it also uses a scheduler which multiplies the learning rate with 0.5 if the validation loss does not improve for 10 consecutive epochs.

In TABLE 1, the TTI lag varies from 10 to 50 and observe the testing Xcorrelation. It can show that TTI lag plays an important role in SSM-based CHPD task, where larger TTI lag often leads to an improvement on the performance. On the other hand, because of the recurrent computation nature of the inference procedure of SSM, the complexity, i.e., number of FLOPs, also increases linearly w.r.t. the TTI lag. For the remaining of this present disclosure, if not particularly mentioned, it may use l=50. Note that, as discussed in the present disclosure, the choice of the TTI lag is a trade-off between performance and complexity, one may tune this parameter w.r.t. the dataset, model and complexity constraints to obtain the suitable hyperparameter. It uses the sample and hold (S and H) method, where the next TTI prediction is exactly the current TTI input, as the performance baseline.

TABLE 1
Effect of the TTI-lag on SSM-based CHPD task

| | State | Num | Training | | | | |
|---|---|---|---|---|---|---|---|
| Model | Dim | Layers | Size | Lag | XCorr | FLOPs | #Parameters |
| Bi-GRU | 32 | 3 | 460,265 | 10 | 0.548 | 565M | 45K |
| Bi-GRU | 32 | 3 | 460,265 | 20 | 0.630 | 1.12G | 45K |
| Bi-GRU | 32 | 3 | 460,265 | 30 | 0.655 | 1.69G | 45K |
| Bi-GRU | 32 | 3 | 460,265 | 40 | 0.666 | 2.23G | 45K |
| Bi-GRU | 32 | 3 | 460,265 | 50 | 0.669 | 2.82G | 45K |
| S and H | NA | NA | NA | NA | 0.501 | NA | NA |

In one experiment, it further explores different architectures of bidirectional GRU networks. It explores Bi-GRU with hidden state dimensions of 16, 32, 64 and 128. The number of layers varies between 1, 3, and 5. In TABLE 2, it shows the results of these different configurations. It can show that Bi-GRU with 128 hidden state size and 5 layers structure performs the best, reaching 0.757 testing Xcorrelation. However, this architecture also induces significant computation overhead, where the number of FLOPs reaches 85G. Similar to the TTI-lag, it leaves the choice of hidden state dimension and number of layers as hyperparameters to be tuned for the specific dataset, model and complexity constraints.

TABLE 2
Performance on different architectures of the bidirectional
GRU network for CHPD task

| | State | Num | Training | | | | |
|---|---|---|---|---|---|---|---|
| Model | Dim | Layers | Size | Lag | XCorr | FLOPs | #Parameters |
| Bi-GRU | 16 | 1 | 460,265 | 50 | 0.544 | 509M | 8K |
| Bi-GRU | 32 | 1 | 460,265 | 50 | 0.625 | 1.2G | 19K |
| Bi-GRU | 64 | 1 | 460,265 | 50 | 0.660 | 3.19G | 50K |
| Bi-GRU | 128 | 1 | 460,265 | 50 | 0.683 | 9.52G | 149K |
| Bi-GRU | 16 | 3 | 460,265 | 50 | 0.639 | 1.11G | 18K |
| Bi-GRU | 32 | 3 | 460,265 | 50 | 0.669 | 2.82G | 45K |
| Bi-GRU | 64 | 3 | 460,265 | 50 | 0.715 | 12.69G | 199K |
| Bi-GRU | 128 | 3 | 460,265 | 50 | 0.730 | 47.38G | 742K |
| Bi-GRU | 16 | 5 | 460,265 | 50 | 0.635 | 1.71G | 27K |
| Bi-GRU | 32 | 5 | 460,265 | 50 | 0.685 | 5.98G | 94K |
| Bi-GRU | 64 | 5 | 460,265 | 50 | 0.717 | 22.18G | 348K |
| Bi-GRU | 128 | 5 | 460,265 | 50 | 0.757 | 85.24G | 1.34M |
| S and H | NA | NA | NA | NA | 0.501 | NA | NA |

In TABLE 3, it shows experiment performance on various SSMs, including bidirectional LSTM, unidirectional GRU, unidirectional LSTM as well as Mamba, on the task of CHPD. It also lists the performance of bidirectional GRU for comparison. Overall, for complexity around 1G FLOPs, Mamba with 32 state dimensions and 16 model dimensions performs the best, while for higher complexity constraints, bidirectional GRU performs the best. Unidirectional RNNs in general underperform compared to their bidirectional counterparts.

TABLE 3
Experiment performance on various SSMs for CHPD task

| | Architecture | | | | | | |
|---|---|---|---|---|---|---|---|
| | Configuration | | | | | | |
| | State | Num | | | Performance | | |
| Model | Dim | Layers | | Lag | XCorr | FLOPs | #Parameters |
| Bi-GRU | 16 | 3 | | 50 | 0.639 | 1.11G | 18K |
| Bi-GRU | 32 | 3 | | 50 | 0.669 | 2.82G | 45K |
| Bi-GRU | 64 | 3 | | 50 | 0.715 | 12.69G | 199K |
| Bi-GRU | 128 | 3 | | 50 | 0.730 | 47.38G | 742K |
| Bi-LSTM | 16 | 3 | | 50 | 0.653 | 1.48G | 23K |
| Bi-LSTM | 32 | 3 | | 50 | 0.686 | 4.79G | 76K |
| Bi-LSTM | 64 | 3 | | 50 | 0.715 | 16.92G | 266K |
| Bi-LSTM | 128 | 3 | | 50 | 0.722 | 63.19G | 989K |
| Uni-GRU | 32 | 3 | | 50 | 0.610 | 1.41G | 22K |
| Uni-GRU | 64 | 3 | | 50 | 0.632 | 4.77G | 75K |
| Uni-LSTM | 32 | 3 | | 50 | 0.601 | 1.88G | 30K |
| Uni-LSTM | 64 | 3 | | 50 | 0.638 | 6.37G | 100K |
| | State | Num | Model | | | | |
| | Dim | Layers | Dim | | | | |
| Mamba | 16 | 4 | 32 | 50 | 0.635 | 676M | 115K |
| Mamba | 32 | 4 | 16 | 50 | 0.686 | 1.11G | 231K |
| Mamba | 16 | 4 | 16 | 50 | 0.561 | 601M | 100K |
| Mamba | 32 | 4 | 32 | 50 | 0.632 | 1.48G | 212K |
| Mamba | 32 | 4 | 64 | 50 | 0.682 | 4.31G | 475K |
| Mamba | 64 | 4 | 32 | 50 | 0.666 | 2.61G | 237K |
| S and H | NA | NA | NA | NA | 0.501 | NA | NA |

In one embodiment, SSM-based channel prediction with a vision encoder is provided. The dynamic and highly variable nature of wireless communication channels may necessitate advanced methods capable of accurately predicting future channel states. Generally, approaches often fall short in capturing both the temporal dependencies and spatial structures inherent in such data. In the present disclosure, the general framework of leveraging SSM is illustrated for the CHPD problem in FIG. 9. In the present disclosure, to address the mentioned-challenges, vision models are provided, particularly ResNet architecture, as the encoder (e.g., Φ)/decoder (e.g., Ψ) structure.

RNNs are well-suited for time-series prediction tasks because of their ability to model sequential dependencies. In the context of channel prediction, where the state of the channel evolves over time, RNNs enable the model to learn how current and past channel states and RBs influence future ones. This capability makes them an ideal choice for capturing the temporal dynamics of communication channels.

In addition to temporal dependencies, the input data in channel prediction often exhibits rich spatial structures, particularly in the form of time-frequency matrices in this context. To extract meaningful spatial features, it utilizes ResNet, a deep convolutional neural network architecture known for its residual connections and strong feature extraction capabilities on image-like data. By acting as an encoder, ResNet transforms the structured input at each time step into an informative latent representation. This representation preserves critical spatial information while reducing irrelevant details.

The output of channel prediction in our case involves reconstructing a structured representation: i.e., a 2D complex valued channel state information (CSI) matrix. To achieve this, ResNet is also employed as a decoder. Its ability to process and reconstruct spatially complex data ensures that the predicted channel states retain their fine spatial details and structural integrity. This decoding process transforms the latent representations generated by the SMM into the final output format, enabling accurate reconstruction of the predicted channel states.

By integrating ResNets as encoders and decoders with our SMM-based solution, the provided method achieves a seamless combination of spatial and temporal modeling. The ResNet encoder extracts high-level spatial features at each time step, while the RNN captures their temporal evolution. Finally, the ResNet decoder reconstructs the structured output, ensuring fidelity and precision. This synergistic approach allows the model to address the challenges of channel prediction with enhanced accuracy and robustness, making it well-suited for modern communication systems.

It may state that the provided procedure works with arbitrary choice of the antenna mapping. For this embodiment, it considers an identity mapping as the antenna mapping η, i.e., d=1 in FIG. 9. As a result, it will omit the antenna mapping η in the following demonstration.

In one embodiment, residual networks (ResNet) are provided. ResNet is a deep learning architecture introduced to address the problem of vanishing gradients that often occurs when training very deep neural networks. The key innovation in ResNet is the introduction of residual blocks, which allow the network to learn residual functions with reference to the layer inputs, rather than trying to learn unreferenced functions. Each residual block includes shortcut connections that bypass one or more layers, enabling the network to learn identity mappings. This architecture allows very deep networks to be trained efficiently by mitigating the degradation problem, where increasing depth leads to higher training error, often due to the gradient vanishing issue.

The primary benefit of ResNet is that it enables the construction of extremely deep networks, such as Resnet-50, ResNet-101, and even deeper, without suffering from vanishing gradients, leading to improved accuracy in complex tasks. ResNet has been widely adopted in various applications, including image classification, object detection, and image denoising/restoration, where its ability to learn deep and complex features has set new benchmarks in performance.

In one embodiment, the framework is adopted as shown in FIG. 12, where the first two subfigures illustrate the encoder and decoder frameworks, respectively while the last subfigure shows the ResNet model that is adopted. For the encoder, recall in FIG. 9, it shares the encoder for every TTI's input tensor. In operation 1001, it starts with the per-TTI input channel under the delay angle domain of size Nₐ×N_{ƒ}×2, it then passes the input into a convolutional network mapping from 2 channels to C channels in operation 1002. It then feeds the intermediate representation into operation 1003, which comprises b number of ResNet blocks. Each one of ResNet blocks shares the same architecture and comprises a series of 2D convolution, batch-normalization as well as activation functions, through operations 1003-A to 1003-E, as shown in the bottom subfigure. After, the skip connection is applied in operation 1003-F to obtain the sum of the layer input and the output features of 1003-E, and this is subsequently fed into the activation function and the output of the ResNet block is obtained.

After applying a series of ResNet blocks, it obtains the latent representation for the current TTI input, of size Nₐ×N_{ƒ}×C. Then for the decoder part, the process is similar but in reversed order. It starts with the Nₐ×N_{ƒ}×M SSM output in operation 1005, where M is the hidden state dimension of the SSM. Note that 805 is the output of an SSM given the entire input trajectory of L channels. It then passes it to b number of ResNet blocks in 1006, which is followed by a channel shrinking convolution output layer mapping from c channels to 2, which refers to the real and imaginary decomposition of the predicted CSI.

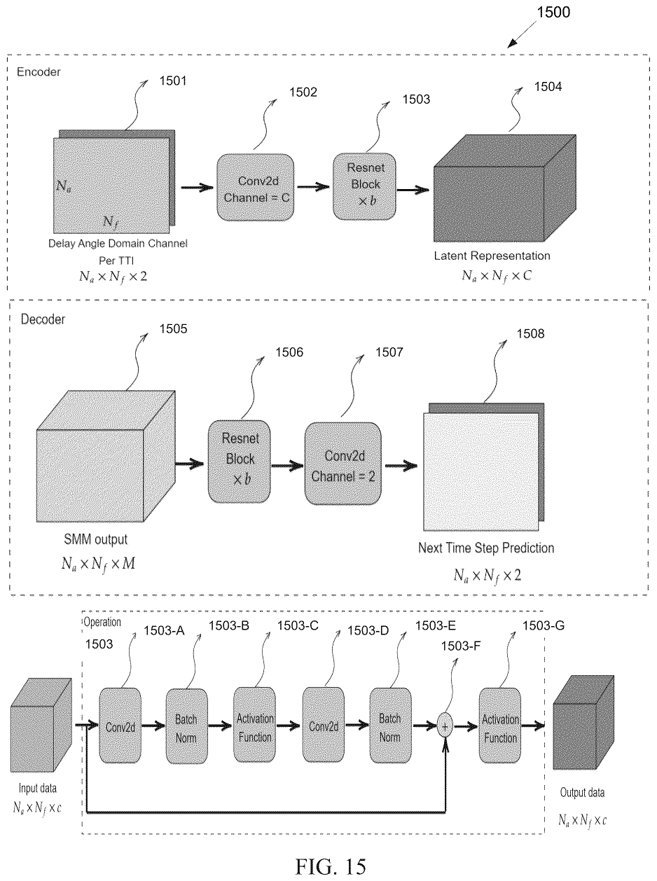

FIG. 15 illustrates examples of a ResNet model structure and encoder/decoder frameworks 1500 according to various embodiments of the present disclosure. An embodiment of the ResNet model structure and encoder/decoder frameworks 1500 shown in FIG. 15 is for illustration only.

In the present disclosure, the experiment results are illustrated on various configurations of the provided architecture as shown in FIG. 15. In the experiment, it uses (1, 3) kernel size for all convolutional operations, the correlation over the antenna dimension offers little contribution to the CHPD task in our dataset. Note that this kernel size may be tuned for other types of datasets.

In TABLE 4, the performance of the provided framework with ResNet encoder/decoder under Bi-GRU CHPD solution is provided. It uses Bi-GRU with linear encoder/decoder as the baseline, which reaches 0.669 Xcorrelation. It compares this baseline with the same network architecture but with ResNet encoder/decoder of various blocks as illustrated in FIG. 15. It can show significant performance boost with only 1 layer of ResNet encoder/decoder, reaching 0.829 Xcorrelation, where the encoding dimension C is set to 64 for all Bi-GRU with ResNet encoder/decoder. It notes that by increasing the number of blocks of the ResNet encoder/decoders, it shows marginal performance gain but significant increase in the number of FLOPs as well as number of parameters, using Bi-GRU as the backbone SSM of the solution. Although the best performance is achieved by 3 blocks of encoder and decoder structure, reaching 0.843 Xcorrelation, the complexity also increases significantly to 9.31G FLOPS.

TABLE 4
ResNet encoder/decoder with Bi-GRU CHPD performance

| | Encoder | Decoder | State | | | | |
|---|---|---|---|---|---|---|---|
| Model | Blocks | Blocks | Dim | Lag | XCorr | FLOPs | #Parameters |
| Bi-GRU | 1 | 1 | 32 | 50 | 0.829 | 6.03G | 120K |
| Bi-GRU | 2 | 2 | 32 | 50 | 0.829 | 7.67G | 170K |
| Bi-GRU | 3 | 3 | 32 | 50 | 0.843 | 9.31G | 220K |
| Bi-GRU | 0 | 0 | 32 | 50 | 0.669 | 2.82G | 45K |

In TABLE 5, the ablation study of the effect on ResNet encoder/decoder architecture is provided. It compares the architecture of both ResNet encoder and decoder with the architecture of only one such component. In this experiment, when the number of encoder blocks is 0, it uses a linear mapping from the input features (of size 2) to the encoded representation (of size 64) as the encoder; when the number of decoder blocks is 0, it uses a linear mapping from the SSM hidden states (of size 32) to the output features (of size 2) as the decoder. One can observe the importance of having both ResNet encoder and ResNet decoder in the network architecture as none of the architectures with only one such component, no matter how large/complex the model is, can outperform Bi-GRU with even just one ResNet encoder and decoder.

TABLE 5
Ablation study of the effect of ResNet encoder/decoder architecture

| | Encoder | Decoder | State | | | | | |
|---|---|---|---|---|---|---|---|---|
| Model | Blocks | Blocks | Dim | Encoding Dim | Lag | XCorr | FLOPs | #Parameters |
| Bi-GRU | 1 | 1 | 32 | 64 | 50 | 0.829 | 6.03G | 120K |
| Bi-GRU | 2 | 2 | 32 | 64 | 50 | 0.829 | 7.67G | 170K |
| Bi-GRU | 3 | 3 | 32 | 64 | 50 | 0.843 | 9.31G | 220K |
| Bi-GRU | 0 | 1 | 32 | 64 | 50 | 0.723 | 3.63G | 82K |
| Bi-GRU | 1 | 0 | 32 | 64 | 50 | 0.719 | 6.0G | 94K |
| Bi-GRU | 0 | 2 | 32 | 64 | 50 | 0.738 | 3.66G | 107K |
| Bi-GRU | 2 | 0 | 32 | 64 | 50 | 0.723 | 7.60G | 119K |
| Bi-GRU | 0 | 4 | 32 | 64 | 50 | 0.741 | 3.72G | 157K |
| Bi-GRU | 4 | 0 | 32 | 64 | 50 | 0.729 | 10.80G | 169K |
| Bi-GRU | 0 | 6 | 32 | 64 | 50 | 0.736 | 3.78G | 206K |
| Bi-GRU | 6 | 0 | 32 | 64 | 50 | 0.744 | 14.02G | 219K |

In TABLE 6, the performance gain is illustrated for other types of SSMs using ResNet as encoder/decoder. It investigated for unidirectional GRU, unidirectional LSTM as well as Mamba. It can show they have all observed significant performance gain for adopting ResNet as the encoder/decoder architecture. Among them, Mamba obtains the most performance gain, from 0.666 Xcorrelation to 0.823 Xcorrelation with 3 blocks of ResNet encoder/decoder.

TABLE 6
Performance gain for other SSMs using ResNet as encoder/decoder

| | Encoder | Decoder | State | Encoding | Num | | | | |
|---|---|---|---|---|---|---|---|---|---|
| Model | Layers | Layers | Dim | Dim | Layers | Lag | XCorr | FLOPs | #Parameters |
| Uni-GRU | 1 | 1 | 32 | 64 | 3 | 50 | 0.743 | 3.83G | 66K |
| Uni-GRU | 3 | 3 | 32 | 64 | 3 | 50 | 0.731 | 7.06G | 129K |
| Uni-GRU | 0 | 0 | 32 | NA | 3 | 50 | 0.610 | 1.41G | 22K |
| Uni-LSTM | 1 | 1 | 32 | 64 | 3 | 50 | 0.710 | 4.29G | 74K |
| Uni-LSTM | 3 | 3 | 32 | 64 | 3 | 50 | 0.721 | 7.53G | 136K |
| Uni-LSTM | 0 | 0 | 32 | NA | 3 | 50 | 0.601 | 1.88G | 30K |
| Mamba | 1 | 1 | 64 | 32 | 4 | 50 | 0.791 | 2.07G | 176K |
| Mamba | 3 | 3 | 64 | 32 | 4 | 50 | 0.823 | 4.20G | 278K |
| Mamba | 0 | 0 | 64 | NA | 4 | 50 | 0.666 | 2.61G | 237K |

In one embodiment, complexity reduction of SSM-based CHPD via RB stacking is provided. The rapid evolution of wireless communication systems, including 5G and beyond, has introduced unprecedented demands on computational efficiency for tasks such as channel prediction. Machine learning (ML)-based approaches have emerged as powerful tools for capturing the complex, nonlinear dynamics of wireless channels. However, these methods often come with significant computational complexity, which poses challenges for practical deployment in real-world systems. Reducing this complexity is a critical research goal, motivated by several key considerations.

First, communication systems operate under stringent real-time constraints. Channel prediction may be performed with minimal latency to adapt to rapidly changing environments, especially in scenarios involving high mobility or dense user populations. High computational complexity in ML models can introduce delays that degrade the overall system performance, leading to increased error rates and reduced quality of service. Reducing complexity ensures that channel predictions can meet the latency requirements or goals for real-time operation.

Second, computational resources in wireless systems are often limited, particularly in edge devices such as mobile phones, Internet of Things (IoT) devices, and autonomous vehicles. These devices typically have constrained processing power, memory, and energy budgets, making it impractical to deploy resource-intensive ML models. Simplifying the computational demands of channel prediction models enables their deployment on such resource-constrained devices, expanding their applicability to a wider range of use cases.

Third, reducing computational complexity contributes to energy efficiency, which is a critical factor in modern communication networks. Energy consumption in base stations, user equipment, and cloud infrastructure is directly impacted by the computational load of the ML models employed. By designing efficient models with reduced complexity, it is possible to lower energy usage, thereby supporting greener and more sustainable communication systems.

Fourth, the scalability of ML-based channel prediction models is significantly affected by their computational complexity. In large-scale networks with many users, devices, and antennas, the computational overhead of complex models can quickly become a bottleneck. Reducing complexity allows for scalable solutions that can handle the increasing demands of large-scale networks without compromising performance.

Lastly, reducing computational complexity facilitates faster model training and deployment. Complex models may require extensive computational resources during both the training phase and inference phase, which can hinder rapid prototyping and real-time updates. Efficient models with lower complexity reduce the time for training and enable faster adaptation to new environments, enhancing the agility of ML-based solutions.

In one embodiment, a complexity overhead of SSM-based CHPD solutions is provided.

The application of SSMs to channel prediction tasks can result in high computational complexity due to several intrinsic characteristics of SSMs and the demands of the channel prediction problem.

A fundamental aspect of SSMs is their sequential processing nature. Unlike typical neural networks, like convolutional neural networks for example, which allow parallel computation for all inputs, SSMs compute each time step sequentially, with each computation depending on the output of the previous step. This dependency significantly limits parallelization and increases computational time during both training and inference. Even though model SSMs like Mamba circumvent this issue in training by leveraging the so-called selective scan as a hardware-aware state expansion method. Mamba still may perform inference in a linear fashion.

In channel prediction tasks, where temporal dependencies play a crucial role, long input sequences are often used to capture the channel's dynamic behavior. The longer the sequence, the greater the number of sequential operations, leading to higher computational demands.

Additionally, the hidden state in an RNN may be updated at every time step using matrix multiplications involving the input, the previous hidden state, and the network weights. The computational complexity grows quadratically w.r.t. the input dimension and state size. As one can see in TABLE 3, with 128 hidden states, Bi-GRU reaches the highest performance, however the complexity is extremely high, with 47.38G number of floating point operations.

The computational burden is further amplified when considering advanced RNN variants like long short-term memory (LSTM) networks or gated recurrent units (GRUs), which introduce additional gates and internal states to manage long-term dependencies. While these mechanisms improve the modeling of temporal dependencies, they also increase the number of parameters and matrix operations per time step, further raising the computational cost.

Finally, the iterative training process of RNNs contributes to their computational complexity. Backpropagation through time (BPTT), the standard algorithm for training RNNs, involves unrolling the network across all time steps and computing gradients through the entire sequence. This process is not only computationally intensive but also memory demanding, particularly for long sequences or large models, making it a challenge for systems with limited computational resources.

In one embodiment, an RB stacking is provided. In FIG. 13, the RB stacking method is illustrated for reducing SSM-based CHPD solution complexity. It states that the provided procedure works with arbitrary choice of the antenna mapping. For this embodiment, it considers an identity mapping as the antenna mapping η, i.e., d=1 in FIG. 9. As a result, it will omit the antenna mapping η in the following demonstration. To begin with, it starts in operation 1101 with the same input tensor under delay angle domain channel of size Nₐ×N_{ƒ}×2L. Note the 2 here refers to the real and imaginary decomposition of the original channel matrix. Then, given s∈ [symbol] ⁺ such that N_{ƒ} mod s=0, it splits the RBs into N_{ƒ}/s number of blocks, where each block contains s RBs. Then in operation 1103, it performs a reshaping operation to merge s different RBs within the same splitted block into the feature dimension.

For example, in 1103, it shows the operation on one of such blocks, reshaping the block from size Nₐ×s×2L into a matrix of size Nₐ×2sL. It then performs this operation for each of these split blocks and stacks the reshaped matrix along the RB dimension. This then gives us a data tensor of shape

$${N}_{a} \times ( \frac{{N}_{f}}{s} ) \times 2 s L .$$

It then separates the TTI dimension out from the feature dimension and obtains the data of shape

$${N}_{a} \times ( \frac{{N}_{f}}{s} ) \times 2 s \times L .$$

This entails that the data is of L number of TTIs, where at each TTI, the input tensor is of size

$${N}_{a} \times \frac{{N}_{f}}{s} \times 2 s ,$$

instead of the original shape Nₐ×N_{ƒ}×2. Then similar to before, it feeds the data tensor in 1105 into some shared encoder in operation 1106 and obtains the encoded delay angle domain representation tensor of shape

$${N}_{a} \times \frac{{N}_{f}}{s} \times c \times L ,$$

where c is the encoding dimension.

After that, the solution is the same as the original pipeline shown in FIG. 9, it will omit the details for simplicity. Note that for s=1, it may recover exactly the original method. Note that although the increased number of features per time step (due to the RB stacking) increases the computational complexity of the encoder, it is significantly less expensive compared to the recurrent computation in SSM state updates, especially with large value of L and N_{ƒ}. Therefore, the RB stacking operation still drastically improves the overall computational efficiency.

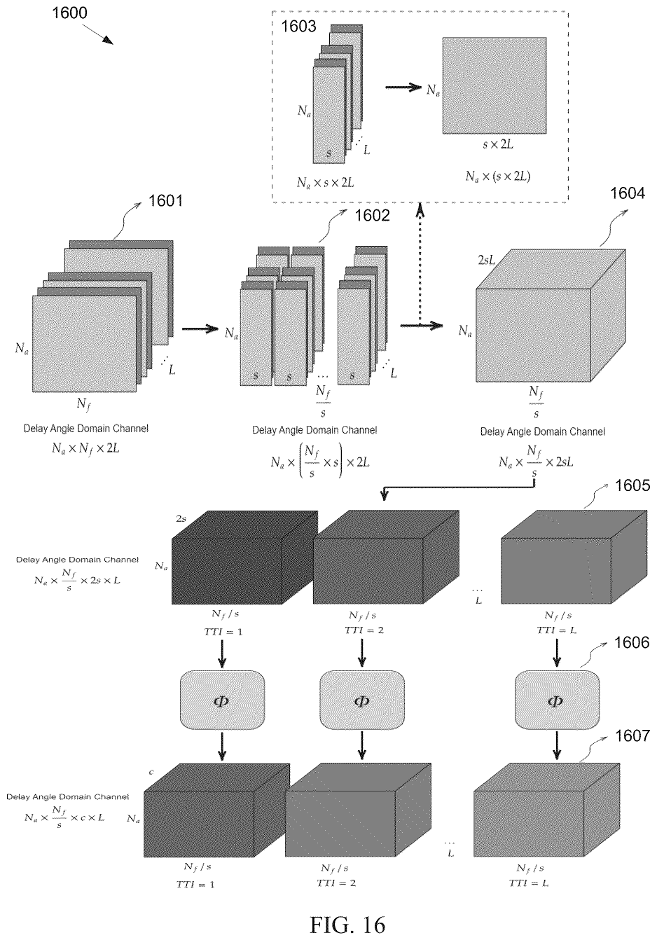

FIG. 16 illustrates examples of an RB stacking for complexity reduction 1600 according to various embodiments of the present disclosure. An embodiment of the RB stacking for complexity reduction 1600 shown in FIG. 16 is for illustration only.

In the present disclosure, the experiment performance is illustrated for SSM-based CHPD solutions with RB stacking. It may use bidirectional GRU as the base SSM and ResNet as the encoder/decoder for our CHPD solution. Note that one can change the base SSM to any kind and the framework still holds. In all experiments of the present disclosure, it opts to use 50 as the input data lag and 20 as the truncation, i.e., N_{q} as illustrated in FIG. 8.

In TABLE 4, it first shows the reduction of complexity for the Bi-GRU method. With 1 encoder and 1 decoder layer, 32 state dimensions and 64 encoding dimensions, the Bi-GRU model without RB stacking originally including 6.03G number of float operations in a single forward pass. For 2 stacks, i.e., every two consecutive RBs merged into one (s=2), the number of FLOPs reduced by almost half while the performance dropped only slightly, from 0.829 to 0.810. When the number of stacks increased to 4, it sees further reduction in the number of FLOPs, reaching 1.53G, which is a quarter of the original number.

The performance, on the other hand, suffers from a slightly more significant drop, from 0.829 to 0.782. As it increases the stack, it can see gradual decline on the Xcorrelation performance and improvement on the model efficiency (lower FLOPs). For example, when s=20, i.e., all RBs (it uses truncation N_{q}=20) from one TTI are merged into one, Xcorrelation declined to 0.673 while the number of FLOPs is only 325M. Note that with increasing stack, the number of parameters also increases a little bit. This is due to the fact that the number of input features at each time step, i.e., 2 s, is increasing, which boosts the number of parameters in the ResNet encoder.

TABLE 7
Experiment performance illustrating complexity reduction for RB stacking method

| | Encoder | Decoder | State | Encoding | | | | |
|---|---|---|---|---|---|---|---|---|
| Model | Layers | Layers | Dim | Dim | Stack | XCorr | FLOPs | #Parameters |
| Bi-GRU | 1 | 1 | 32 | 64 | 1 | 0.829 | 6.03G | 120K |
| Bi-GRU | 1 | 1 | 32 | 64 | 2 | 0.810 | 3.03G | 120K |
| Bi-GRU | 1 | 1 | 32 | 64 | 4 | 0.782 | 1.53G | 122K |
| Bi-GRU | 1 | 1 | 32 | 64 | 5 | 0.732 | 1.22G | 123K |
| Bi-GRU | 1 | 1 | 32 | 64 | 10 | 0.680 | 626M | 126K |
| Bi-GRU | 1 | 1 | 32 | 64 | 20 | 0.673 | 325M | 134K |

It then proceeds to show experiment results for some other configurations. It explored with both 1 encoder/decoder and 3 encoders/decoders architecture. Additionally, it explored 32 and 64 state dimensions as well as 32 and 16 encoding dimensions. For number of stacks, it focuses on 2 and 4. In TABLE 5, it shows the experiment results of this exploration. It also presents the best model performance on this table (highlighted red). From these configurations, the best performance is achieved by Bi-GRU with 1 encoder and 1 decoder with 64 state dimensions and 16 encoding dimensions. This configuration reaches 0.842 Xcorrelation, and the number of FLOPs is 5.9G. Note that the performance is similar to the previous best model without RB stacking, while achieving more than ⅓ FLOPs reduction. For a relatively lower performance, at 0.796 Xcorrelation, Bi-GRU with 1 encoder/decoder, 32 state dimension, 16 encoding dimension and 2 stacks only requires 1.6G FLOPs, further reducing the inference complexity while only observing around 0.05 Xcorrelation loss.

TABLE 8
Other explored model configurations for Bi-GRU-based CHPD solution with RB stacking

| | Encoder | Decoder | State | Encoding | | | | |
|---|---|---|---|---|---|---|---|---|
| Model | Layers | Layers | Dim | Dim | Stack | XCorr | FLOPs | #Parameters |
| Bi-GRU | 3 | 3 | 32 | 64 | 1 | 0.843 | 9.31G | 220K |
| Bi-GRU | 1 | 1 | 32 | 32 | 2 | 0.803 | 1.93G | 86K |
| Bi-GRU | 3 | 3 | 32 | 32 | 2 | 0.811 | 2.37G | 149K |
| Bi-GRU | 1 | 1 | 32 | 32 | 4 | 0.755 | 970M | 87K |
| Bi-GRU | 3 | 3 | 32 | 32 | 4 | 0.763 | 1.19G | 150K |
| Bi-GRU | 1 | 1 | 32 | 16 | 2 | 0.796 | 1.60G | 76K |
| Bi-GRU | 3 | 3 | 32 | 16 | 2 | 0.808 | 1.73G | 129K |
| Bi-GRU | 1 | 1 | 32 | 16 | 4 | 0.732 | 803M | 77K |
| Bi-GRU | 3 | 3 | 32 | 16 | 4 | 0.739 | 872M | 130K |
| Bi-GRU | 1 | 1 | 64 | 16 | 2 | 0.842 | 5.90G | 284K |
| Bi-GRU | 3 | 3 | 64 | 16 | 2 | 0.840 | 6.13G | 485K |
| Bi-GRU | 1 | 1 | 64 | 16 | 4 | 0.789 | 2.95G | 286K |
| Bi-GRU | 3 | 3 | 64 | 16 | 4 | 0.773 | 3.07G | 487K |

Enabling accurate channel prediction is critical for massive MIMO systems and it has broad use cases: (i) enabling robust MU-MIMO system with improved cell throughput performance; and (ii) enhancing the communication for highly dynamic systems, e.g., vehicle to everything (V2X), which is crucial for applications such as autonomous driving, etc.

Channel state information prediction (e.g., AI-based CSI) is one of the keys enabling physical layer technologies in wireless communication systems. In the present disclosure, it shows that the provided CSI prediction solution that exploits temporal correlation in delay angle transformed domain using SSMs can achieve superior performance with a manageable complexity.

The models are trained using simulated environment with particular random seeds and configurations.

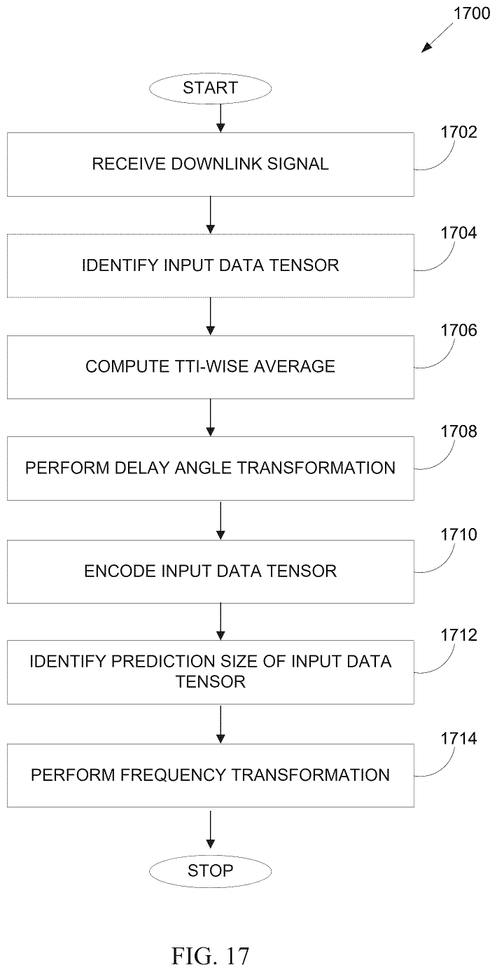

FIG. 17 illustrates a flowchart of a method 1700 for a CSI prediction with timing and frequency offsets impairments via state space models according to various embodiments of the present disclosure. The method 1700 may be performed by a UE (e.g., 111-116 as illustrated in FIG. 1). An embodiment of the method 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As illustrated in FIG. 17, the method 1700 begins at step 1702. In step 1702, a UE receives, from a BS, a downlink signal.

Subsequently, in step 1704, the UE identifies, based on the downlink signal, an input data tensor in a frequency domain.

Subsequently, in step 1706, the UE computes, based on the input data tensor, a TTI-wise average to obtain a TTI-wise normalized value by performing a TTI-wise division operation.

Subsequently, the UE in step 1708 performs, based on the TTI-wise normalized value, a delay angle transformation to obtain RBs. In such step, each of the RBs is identified as a different time step.

Subsequently, the UE in step 1710 encodes, based on the RBs, the input data tensor per-TTI channel matrix.

Next, the UE in step 1712 identifies a prediction size of the input data tensor in a delay-angle domain using an ML model.

Finally, the UE in step 1714 performs, based on the prediction size of the input data tensor, a frequency transformation for a channel prediction operation, wherein a decoder is used to recover a predicted channel after performing the channel prediction operation.

In one embodiment, the UE identifies, based on the input data tensor, an input data sequence and sequentially processes the input data sequence using unidirectional RNNs to perform the channel prediction operation. In such embodiment, a length of the input data sequence is identical to a length of an output data sequence that is sequentially processed using the unidirectional RNNs.

In one embodiment, the UE identifies, based on the input data tensor, an input data sequence and bidirectionally processes the input data sequence using BRNNs to perform the channel prediction operation, including a forward processing in a forward direction and a backward processing in a backward direction. In such embodiment, the BRNNs use current channel information for the forward processing and past channel information for the backward processing, respectively.

In one embodiment, the UE processes the input data tensor using GRUs comprising update gates and reset gates to perform the channel prediction operation. In such embodiment, the update gates are used to identify a number of pieces of past information to be used for the channel prediction operation and the reset gates are used to identify a number of pieces of past information not to be for the channel prediction operation.

In one embodiment, the UE processes the input data tensor using a LSTM comprising input gates, forget gates, and output gates to perform the channel prediction operation. In such embodiment, the input gates are used to identify a number of pieces of input information to be used for the channel prediction operation, the forget gates are used to identify a number of pieces of the input information not to be used for the channel prediction operation, and the output gates are used to identify a number of pieces of output information to be used for channel prediction operation.

In one embodiment, the UE maps, based on a convolutional mapping operation, the input data tensor to a plurality of channels from two channels; identifies, based on the mapped input data tensor, an intermediate representation using a number of residual neural networks (Resnet) blocks, wherein each of the number of Resnet blocks includes a 2D convolution function, a batch normalization function, and an activation function; and identifies, based on the intermediate representation, a latent representation for a TTI input.

In one embodiment, the UE identifies output data of a SSM using a Resnet, wherein the output data is associated with a hidden dimension of the SSM, the SSM sequentially computing a time step of the output data and identifies, based on the output data, the two channels using a channel shrinking convolutional output layer mapping operation, wherein the two channels are derived from the plurality of channels.

In one embodiment, the UE splits the RBs into a number of blocks, performs a reshaping operation to merge a plurality of RBs in each of the number of blocks into an RB dimension, each of the number of blocks is resized to generate reshaped matrix, stacks the reshaped matrix along with the RB dimension, and generates, based on the stacked reshaped matrix along with the RB dimension, a new input data tensor.

In such embodiments, the reshaped matrix along with the RB is stacked from consecutive TTIs.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the claims appended. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a base station (BS), a downlink signal; and
a processor operably coupled to the transceiver, the processor configured to:
identify, based on the downlink signal, an input data tensor in a frequency domain,
compute, based on the input data tensor, a transmission time interval (TTI)-wise average to obtain a TTI-wise normalized value by performing a TTI-wise division operation,
perform, based on the TTI-wise normalized value, a delay angle transformation to obtain resource blocks (RBs), wherein each of the RBs is identified as a different time step,
encode, based on the RBs, the input data tensor per-TTI channel matrix,
identify a prediction size of the input data tensor in a delay-angle domain using a machine learning (ML) model, and
perform, based on the prediction size of the input data tensor, a frequency transformation for a channel prediction operation, wherein a decoder is used to recover a predicted channel after performing the channel prediction operation.

2. The UE of claim 1, wherein:
the processor is further configured to:
identify, based on the input data tensor, an input data sequence, and
sequentially process the input data sequence using unidirectional recurrent neural networks (RNNs) to perform the channel prediction operation; and
a length of the input data sequence is identical to a length of an output data sequence that is sequentially processed using the unidirectional RNNs.

3. The UE of claim 1, wherein:
the processor is further configured to:
identify, based on the input data tensor, an input data sequence;
bidirectionally process the input data sequence using bidirectional recurrent neural networks (BRNNs) to perform the channel prediction operation, including a forward processing in a forward direction and a backward processing in a backward direction; and
the BRNNs use current channel information for the forward processing and past channel information for the backward processing, respectively.

4. The UE of claim 1, wherein:
the processor is further configured to process the input data tensor using gated recurrent units (GRUs) comprising update gates and reset gates to perform the channel prediction operation;
the update gates are used to identify a number of pieces of past information to be used for the channel prediction operation; and
the reset gates are used to identify a number of pieces of past information not to be for the channel prediction operation.

5. The UE of claim 1, wherein:
the processor is further configured to process the input data tensor using a long short-term memory (LSTM) comprising input gates, forget gates, and output gates to perform the channel prediction operation;
the input gates are used to identify a number of pieces of input information to be used for the channel prediction operation;
the forget gates are used to identify a number of pieces of the input information not to be used for the channel prediction operation; and
the output gates are used to identify a number of pieces of output information to be used for channel prediction operation.

6. The UE of claim 1, wherein the processor is further configured to:
map, based on a convolutional mapping operation, the input data tensor to a plurality of channels from two channels;
identify, based on the mapped input data tensor, an intermediate representation using a number of residual neural networks (Resnet) blocks, wherein each of the number of Resnet blocks includes a two-dimensional (2D) convolution function, a batch normalization function, and an activation function; and
identify, based on the intermediate representation, a latent representation for a TTI input.

7. The UE of claim 6, wherein the processor is further configured to:
identify output data of a state space model (SSM) using a Resnet, wherein the output data is associated with a hidden dimension of the SSM, the SSM sequentially computing a time step of the output data; and
identify, based on the output data, the two channels using a channel shrinking convolutional output layer mapping operation, wherein the two channels are derived from the plurality of channels.

8. The UE of claim 1, wherein the processor is further configured to:
split the RBs into a number of blocks;
perform a reshaping operation to merge a plurality of RBs in each of the number of blocks into an RB dimension, each of the number of blocks is resized to generate reshaped matrix;
stack the reshaped matrix along with the RB dimension; and
generate, based on the stacked reshaped matrix along with the RB dimension, a new input data tensor.

9. The UE of claim 8, wherein the reshaped matrix along with the RB is stacked from consecutive TTIs.

10. A method of a user equipment (UE) in a wireless communication system, the method comprising:
receiving, from a base station (BS), a downlink signal;
identifying, based on the downlink signal, an input data tensor in a frequency domain;
computing, based on the input data tensor, a transmission time interval (TTI)-wise average to obtain a TTI-wise normalized value by performing a TTI-wise division operation;
performing, based on the TTI-wise normalized value, a delay angle transformation to obtain resource blocks (RBs), wherein each of the RBs is identified as a different time step;
encoding, based on the RBs, the input data tensor per-TTI channel matrix;
identifying a prediction size of the input data tensor in a delay-angle domain using a machine learning (ML) model; and
performing, based on the prediction size of the input data tensor, a frequency transformation for a channel prediction operation, wherein a decoder is used to recover a predicted channel after performing the channel prediction operation.

11. The method of claim 10, further comprising:
identifying, based on the input data tensor, an input data sequence; and
sequentially processing the input data sequence using unidirectional recurrent neural networks (RNNs) to perform the channel prediction operation,
wherein a length of the input data sequence is identical to a length of an output data sequence that is sequentially processed using the unidirectional RNNs.

12. The method of claim 10, further comprising:
identifying, based on the input data tensor, an input data sequence; and
bidirectionally processing the input data sequence using bidirectional recurrent neural networks (BRNNs) to perform the channel prediction operation, including a forward processing in a forward direction and a backward processing in a backward direction,
wherein the BRNNs use current channel information for the forward processing and past channel information for the backward processing, respectively.

13. The method of claim 10, further comprising processing the input data tensor using gated recurrent units (GRUs) comprising update gates and reset gates to perform the channel prediction operation, wherein:
the update gates are used to identify a number of pieces of past information to be used for the channel prediction operation; and
the reset gates are used to identify a number of pieces of past information not to be for the channel prediction operation.

14. The method of claim 10, further comprising processing the input data tensor using a long short-term memory (LSTM) comprising input gates, forget gates, and output gates to perform the channel prediction operation, wherein:
the input gates are used to identify a number of pieces of input information to be used for the channel prediction operation;
the forget gates are used to identify a number of pieces of the input information not to be used for the channel prediction operation; and
the output gates are used to identify a number of pieces of output information to be used for channel prediction operation.

15. The method of claim 10, further comprising:
mapping, based on a convolutional mapping operation, the input data tensor to a plurality of channels from two channels;
identifying, based on the mapped input data tensor, an intermediate representation using a number of residual neural networks (Resnet) blocks, wherein each of the number of Resnet blocks includes a two-dimensional (2D) convolution function, a batch normalization function, and an activation function; and
identifying, based on the intermediate representation, a latent representation for a TTI input.

16. The method of claim 15, further comprising:
identifying output data of a state space model (SSM) using a Resnet, wherein the output data is associated with a hidden dimension of the SSM, the SSM sequentially computing a time step of the output data; and
identifying, based on the output data, the two channels using a channel shrinking convolutional output layer mapping operation, wherein the two channels are derived from the plurality of channels.

17. The method of claim 10, further comprising:
splitting the RBs into a number of blocks;
performing a reshaping operation to merge a plurality of RBs in each of the number of blocks into an RB dimension, each of the number of blocks is resized to generate reshaped matrix;
stacking the reshaped matrix along with the RB dimension; and
generating, based on the stacked reshaped matrix along with the RB dimension, a new input data tensor.

18. The method of claim 17, wherein the reshaped matrix along with the RB is stacked from consecutive TTIs.

19. A non-transitory computer-readable medium comprising program code, that when executed by at least one processor, causes an electronic device to:
receive, from a base station (BS), a downlink signal;
identify, based on the downlink signal, an input data tensor in a frequency domain;
compute, based on the input data tensor, a transmission time interval (TTI)-wise average to obtain a TTI-wise normalized value by performing a TTI-wise division operation;
perform, based on the TTI-wise normalized value, a delay angle transformation to obtain resource blocks (RBs), wherein each of the RBs is identified as a different time step;
encode, based on the RBs, the input data tensor per-TTI channel matrix;
identify a prediction size of the input data tensor in a delay-angle domain using a machine learning (ML) model; and
perform, based on the prediction size of the input data tensor, a frequency transformation for a channel prediction operation, wherein a decoder is used to recover a predicted channel after performing the channel prediction operation.

20. The computer-readable medium of claim 19, further comprising program code, that when executed by at least one processor, causes an electronic device to:
identify, based on the input data tensor, an input data sequence;
sequentially process the input data sequence using unidirectional recurrent neural networks (RNNs) to perform the channel prediction operation; and
a length of the input data sequence is identical to a length of an output data sequence that is sequentially processed using the unidirectional RNNs.
